(19) United States
(12) Patent Application Publication
(10) Pub. No.: US 2012/0119638 A1
(43) Pub. Date: May 17, 2012

(54) LIGHT EMITTING ELEMENT, LIGHT EMITTING DEVICE, AND METHOD FOR PRODUCING LIGHT EMITTING DEVICE

(75) Inventors: Rina SATO, Osaka-shi (JP); Katsuhiko KISHIMOTO, Osaka-Shi (JP)

(73) Assignee: Sharp Kabushiki Kaisha, Osaka-Shi (JP)

(21) Appl. No.: 13/297,989

(22) Filed: Nov. 16, 2011

(30) Foreign Application Priority Data
Nov. 17, 2010 (JP) 2010-257096

(51) Int. Cl. H01J 7/24; H01J 9/30

(52) U.S. Cl. 313/46; 445/23

(57) ABSTRACT

The present invention provides a light emitting element including a transparent substrate being transparent to laser light L and having a light receiving surface for receiving the laser light L and a reverse surface of the light receiving surface, and a light emitting section for generating fluorescent light upon receiving the laser light having passed through the transparent substrate, the light emitting section being provided to face the reverse surface, the transparent substrate having a heat conductivity and the light receiving surface having or provided with a microstructure in which either or both of a plurality of projections or a plurality of fine pores are arranged with intervals.

This Nonprovisional application claims priority under 35 U.S.C. §119(a) on Patent Application No. 2010-257096 filed in Japan on Nov. 17, 2010, the entire contents of which are hereby incorporated by reference.

### TECHNICAL FIELD

The present invention relates to a fluorescent material (light emitting section) for generating fluorescence by receiving excitation light radiated thereon, a light emitting device provided with the light emitting element, and a method for producing the light emitting element.

### BACKGROUND ART

Recently, a much more number of researches have been carried out nowadays on light emitting devices using, as an excitation light source, a light emitting diode (LED), a semiconductor laser (LD, Laser Diode), or the like in order to utilize as its illumination light, fluorescent light generated by radiating excitation light onto a light emitting section including a fluorescent material, the excitation light being generated by such an excitation light source.

Radiating the excitation light directly on a surface of the light emitting section is associated with such a problem that such direct radiation causes reflection of the excitation light due to a refractive index difference between the light emitting section and air, thereby resulting in lowering radiation efficiency of the radiation of the excitation light onto the light emitting section.

For example, in case where the light emitting section is one using a sealant having a refractive index of 1.7, a degree of reflection at a boundary between the light emitting section and the air reaches about 6.7%. This means that at least about 6.7% of the excitation light is not received by the light emitting section.

Here, the reason why it is put as “at least” about 6.7% of the excitation light is not received by the light emitting section is because the excitation light has the following two possible routes, namely Case A and Case B, as illustrated in FIG. 9 (a).

For example, in Case A, the excitation light travels from the air to the sealant, and then from the sealant to the fluorescent material (see position P1). Thus, the degree of reflection is determined on respective refractive indexes of the air and the sealant. On the other hand, in Case B, the excitation light travels from the air to the fluorescent material. Thus, the degree of reflection is determined on respective refractive indexes of the air and the fluorescent material.

Moreover, there is a possibility that an substantial amount of the excitation light received by the light emitting section may be reduced by dust, stain, oil or the like attached to the surface of the light emitting section, or a minute unevenness on the surface of the light emitting section.

Patent Literature 1 discloses a semiconductor light emitting device as one example of a technique for solving such a problem.

In this semiconductor light emitting device, a light emitting section is provided with an anti-reflection structure directly on a surface thereof. The anti-reflection structure, such as a fine rough structure, prevents the excitation light reflection on the surface of the light emitting section, thereby improving radiation efficiency of the excitation light radiated on the light emitting section.

On the other hand, in order to fix or reinforce a light emitting section, the light emitting section is often so configured that a periphery of the light emitting section is surrounded by a transparent resin member. In this case, however, fluorescent light generated by the light emitting section is reflected at a boundary between the air and the resin material, whereby the reflected fluorescent light remains inside the light emitting section, thereby lowering an output efficiency of the yielded fluorescent light.

Patent Literature 2 discloses an LED illuminating light source as one example of a technique for solving such a problem.

The LED illuminating light source includes an LED chip mounted on a substrate, a light emitting section covering the LED chip, and a transparent resin member covering the light emitting section, wherein an upper surface of the resin member has a rough structure in order to prevent fluorescent light from being reflected on the upper surface of the resin member.

Besides Patent Literature 2, Patent literatures 3, 4, and 6 also disclose techniques relating to fine rough structures. In Patent Literature 3, a rough structure is provided on a surface of fluorescent material fine particles. Meanwhile, a rough structure is provided on a light-emitting side of a color converting member in Patent Literature 4. Moreover, Patent Literature 6 discloses a technique in which triangular pyramid-shaped or quadrangular pyramid-shaped structures in an array are provided for a sheet-shaped color converting element.

Meanwhile, Patent Literatures 5 discloses a technique relating to anti-reflection films, even though they do not relate to fine rough structures.

### CITATION LIST

### Patent Literatures

Patent Literature 1
Japanese Patent Application Publication, Tokukai, No. 2009-158620 (Publication Date: Jul. 16, 2009)

Patent Literature 2
Japanese Patent Application Publication, Tokukai, No. 2006-24615 (Publication Date: Jan. 26, 2006)

Patent Literature 3
Japanese Patent Application Publication, Tokukai, No. 2010-100827 (Publication Date: May 6, 2010)

Patent Literature 4
Japanese Patent Application Publication, Tokukai, No. 2007-103901 (Publication Date: Apr. 19, 2007)

Patent Literature 5
Japanese Patent Application Publication, Tokukai, No. 2010-87324 (Publication Date: Apr. 15, 2010)

Patent Literature 6
Japanese Patent Application Publication, Tokukai, No. 2009-140822 (Publication Date: Jun. 25, 2009)

### SUMMARY OF INVENTION

### Technical Problem

When excitation light of high power and high power density is radiated on the surface of the light emitting section, there would be a possibility that a temperature of the light emitting section easily reaches several hundred ° C. if proper heat release is not performed for the light emitting section.

Therefore, in case where an anti-reflection structure constituted by a fine rough structure is provided directly on the surface of the light emitting material (or fluorescent particles), like the semiconductor light emitting device of Patent Literature and the techniques like Patent Literature 3, the temperature rise of the light emitting material occurs repeatedly every time the light emitting device is turned on. Such repeated temperature rise would possibly deform the rough structure, thereby depriving the rough structure of its anti-reflection function. Thus, in the semiconductor light emitting device of Patent Literature and the technique of Patent Literature 3, their radiation efficiency of the excitation light radiated on the light emitting section cannot be maintained for a long time.

On the other hand, the LED illuminating light source of Patent Literature 2 is configured such that the periphery of the LED chip serving as the excitation light source is directly surrounded with the fluorescent material resin section (light emitting section). Thus, heat generated from the LED chip is directly transferred to the light emitting section. This would possibly lower the light emitting efficiency of the light emitting section, or would conduct the heat to the transparent resin section covering the light emitting section and having the upper surface having the rough structure. The heat conducted to the transparent resin section would deform the rough structure of the transparent resin section. Of course, there is such a problem that the light emitting section itself generates heat by being directly radiated with the excitation light of the high power and high power density, which excitation light is generated from the LED chip. Resultant temperature rise in the light emitting section would possibly deform the rough structure of the upper surface of the transparent resin section.

This is due to the following reason. The resin member, provided to the LED illuminating light source so as to directly cover the light emitting section thereby to provide the upper surface having the rough structure on the light emitting section, has an upper temperature limit of a hundred and several tens ° C. in general. Meanwhile, the temperature rise in the light emitting section is repeated every time the LED illuminating light source is turned on. This repeated temperature rise gradually deforms the rough structure of the resin member having such an upper temperature limit.

Apart from the LED chips, laser light source such as semiconductor laser elements are examples of typical light sources for excitation light having high power and high power density. By using a laser light source, by which laser beam is used as the excitation light, it is possible to realize a very high power and a very high power density. Therefore, the temperature of the light emitting section can be more significantly increased when the laser light source is used as the excitation light source. In this case, the temperature of the light emitting section will be easily increased beyond several hundred ° C. without appropriate heat release, thereby damaging the light emitting section.

However, the techniques of Patent Literatures 4 and 6 are utterly silent about the problem that the rough structure is deteriorated by heat generated from the color converting member or the sheet-shaped color converting element.

Further, the technique of Patent Literature 5 does not relate to rough structures at all.

Meanwhile, in view of the improvement of overall light emission efficiency of the light emitting section, it is preferable to develop a technique considering both of the improvement of the radiation efficiency of the excitation light radiated on the light emitting section and the improvement of the output efficiency of the yielded fluorescent light from the light emitting section, rather than a technique considering either one of them.

For example, the technique recited in Patent Literature 1, part (which is spotted by excitation light source) of the visible light emitting member has a rough structure. But Patent Literature 1 is silent as to improvement in use efficiency of the visible light to be emitted from the light emitting section (i.e., output efficiency of the fluorescent light from the light emitting section).

Moreover, in the technique of Patent Literature 3, a rough structure is provided on a light emitting surface of the light emitting section. However, on the contrary, Patent Literature 3 does not consider at all about reducing waste of the excitation light on the light incident surface of the light emitting section from which incident surface the excitation light from the LED element enters.

The present invention is accomplished in view of the aforementioned problem, and an object of the present invention is to provide a light emitting element etc. capable of achieving a high light emission efficiency of a light emitting section and keeping the high light emission efficiency for a long time.

### Solution to Problem

In order to attain the object, a light emitting element according to the present invention is a light emitting element, including: a transparent substrate (i) having a light receiving surface to which excitation light having a predetermined wavelength is to be radiated, and a reverse surface being opposite to the light receiving surface and (ii) being transparent to the excitation light; and a light emitting section being positioned to face of the reverse surface of the transparent substrate, and being configured to generate fluorescent light upon receiving the excitation light having passed through the transparent substrate, the transparent substrate being heat conductive so as to receive heat generated from the light emitting section and allow diffusion of the heat, and the light receiving surface of the transparent substrate having or provided with a rough structure having either or both of a plurality of protruded parts or a plurality of recessed parts with intervals capable of reducing reflection of the excitation light from the light receiving surface.

According to this configuration, a refractive index difference between air and the rough structure is gradually changed, because the rough structure has either or both of a plurality of protruded parts or a plurality of recessed parts with intervals capable of reducing reflection of the excitation light from the light receiving surface. This significantly degreases a degree of reflection of the excitation light at a boundary between the air and the transparent substrate.

As a result of this, the reflection of the excitation hardly occurs at the boundary between the air and the transparent substrate, which have a large refractive index difference otherwise. This improves radiation efficiency of the excitation light radiated to the light emitting section.

Moreover, a degree of reflection of the fluorescent light at the boundary between the air and transparent substrate is dramatically decreased.

This reduces the reflection of the fluorescent light at the boundary of the air and the transparent substrate, thereby avoiding such a problem that the reflected fluorescent light remains inside the light emitting section. This improves an output efficiency of the yielded fluorescent light.

Further, the light receiving surface and the reverse surface which is the reverse side of the light receiving surface are distanced from each other by the thickness the transparent substrate. In other words, the boundary between the air and the transparent substrate, that is, a refractive index boundary (which refers to the boundary between the air and the transparent substrate) from which the excitation light enters the transparent substrate and at which the rough structure is formed is distanced from a thermal boundary to which the heat from the light emitting section which is a greatest heat source among constituent elements of the light emitting element is conducted to the transparent substrate. By this, the rough structure can be protected from the heat generated from the light emitting section. Thus, the function of the light emitting element of the present invention can be maintained for a long time.

According to this configuration, the light emission efficiency of the light emitting section can be increased, and the high light emission efficiency can be maintained for a long time.

Here, the “protruded parts” are parts extended substantially along a radiation direction of the excitation light reversely. As one alternative, the “protruded parts” are parts located between recessed parts and locally protruded substantially along the radiation direction of the excitation light reversely. Moreover, the “recessed parts” are parts deepened substantially along the radiation direction of the excitation light forwardly. As one alternative, the “recessed parts” are parts located between protruded parts and locally recessed substantially along the radiation direction of the excitation light forwardly.

In order to attain the object, a method according to the present invention is a method for producing a light emitting element being transparent to light emitting light having a predetermined wavelength, and a light emitting section for generating fluorescent light upon receiving the excitation light, the method including: a rough structure forming step for forming a rough structure so that one surface of the transparent has the rough structure, the rough structure having either or both of a plurality of protruded parts or a plurality of recessed parts with intervals capable of reducing reflection of the excitation light from the light receiving surface; and a light emitting section providing step for providing the light emitting section at a position to face of a reverse surface of the transparent substrate, which reverse surface is reverse to the one surface of the transparent substrate, the transparent substrate being made from a material having a heat conductivity to receive heat generated from the light emitting section and allow diffusion of the heat.

According to the method, the rough structure forming step forms a rough structure so that one surface of the transparent has the rough structure, the rough structure having either or both of a plurality of protruded parts or a plurality of recessed parts with intervals capable of reducing reflection of the excitation light from the light receiving surface.

Moreover, the light emitting section providing step provides the light emitting section at a position to face of a reverse surface of the transparent substrate, which reverse surface is reverse to the one surface of the transparent substrate.

Further, the method is arranged such that the transparent substrate is made from a material having a heat conductivity to receive heat generated from the light emitting section and allow diffusion of the heat.

With this method, it is possible to produce a light emitting element in which the light emission efficiency of the light emitting section can be increased, and the high light emission efficiency can be maintained for a long time.

For a fuller understanding of the nature and advantages of the invention, reference should be made to the ensuing detailed description taken in conjunction with the accompanying drawings.

### Advantageous Effects of Invention

As described above, a light emitting element according to the present invention is a light emitting element, including: a transparent substrate (i) having a light receiving surface to which excitation light having a predetermined wavelength is to be radiated, and a reverse surface being opposite to the light receiving surface and (ii) being transparent to the excitation light; and a light emitting section being positioned to face of the reverse surface of the transparent substrate, and being configured to generate fluorescent light upon receiving the excitation light having passed through the transparent substrate, the transparent substrate being heat conductive so as to receive heat generated from the light emitting section and allow diffusion of the heat, and the light receiving surface of the transparent substrate having or provided with a rough structure having either or both of a plurality of protruded parts or a plurality of recessed parts with intervals capable of reducing reflection of the excitation light from the light receiving surface.

As described above, a method according to the present invention is a method for producing a light emitting element being transparent to light emitting light having a predetermined wavelength, and a light emitting section for generating fluorescent light upon receiving the excitation light, the method including: a rough structure forming step for forming a rough structure so that one surface of the transparent has the rough structure, the rough structure having either or both of a plurality of protruded parts or a plurality of recessed parts with intervals capable of reducing reflection of the excitation light from the light receiving surface; and a light emitting section providing step for providing the light emitting section at a position to face of a reverse surface of the transparent substrate, which reverse surface is reverse to the one surface of the transparent substrate, the transparent substrate being made from a material having a heat conductivity to receive heat generated from the light emitting section and allow diffusion of the heat.

With the light emitting element or the method producing the light emitting element, it is possible to achieve such effects that the light emission efficiency of the light emitting section can be increased, and the high light emission efficiency can be maintained for a long time.

### BRIEF DESCRIPTION OF DRAWINGS

FIG. 1 is a cross sectional view schematically illustrating a configuration of a light emitting element according to one embodiment of the present invention.

FIG. 2 is a cross sectional view schematically illustrating a configuration of a light emitting element according to another embodiment of the present invention.

FIG. 3 is a cross sectional view schematically illustrating a configuration of a light emitting device (transparent type) according to still another embodiment of the present invention.

FIG. 4 is a cross sectional view schematically illustrating a configuration of a light emitting device (reflective type) according to still another embodiment of the present invention.

FIG. 5 are cross sectional views schematically illustrating exemplary configurations of a microstructure formed on a light receiving surface of a transparent substrate of the light emitting element, where (a) of FIG. 5 illustrates one exemplary configuration of the microstructure, (b) of FIG. 5 illustrates another exemplary configuration of the microstructure, (c) of FIG. 5 illustrates still another exemplary configuration of the microstructure, (d) of FIG. 5 illustrates yet another exemplary configuration of the microstructure, (e) of FIG. 5 illustrates still yet another exemplary configuration of the microstructure, (f) of FIG. 5 illustrates yet still another exemplary configuration of the microstructure.

FIG. 6 are cross sectional views schematically illustrating more exemplary configurations of a microstructure formed on a light receiving surface of a transparent substrate of the light emitting element, where (a) of FIG. 6 illustrates one exemplary configuration of the microstructure, (b) of FIG. 6 illustrates another exemplary configuration of the microstructure, (c) of FIG. 6 illustrates still another exemplary configuration of the microstructure, (d) of FIG. 6 illustrates yet another exemplary configuration of the microstructure, and (e) of FIG. 6 illustrates still yet another exemplary configuration of the microstructure.

FIG. 7 are views illustrating a process of forming a microstructure on a light-receiving surface of the transparent substrate. (a) of FIG. 7 is a cross sectional view schematically illustrating a sapphire substrate, which is one example of the transparent substrate. (b) of FIG. 7 is a across sectional view schematically illustrating formation of a resist layer on one surface of the sapphire substrate (resist layer formation step). (c) of FIG. 7 is a cross sectional view schematically illustrating light exposure of the resist layer (light exposure step), and (d) of FIG. 7 is a cross sectional view schematically illustrating partial removal of the resist layer, by which the resist layer is partially removed while an exposed portion of the resist layer is remained (removal step).

FIG. 8 are views illustrating a process of etching a sapphire substrate on which the exposed portion is remained. (a) of FIG. 8 is a cross sectional view schematically illustrating etching of the sapphire substrate on which only the exposed portion is remained (etching step), (b) of FIG. 8 is a cross sectional view schematically illustrating the sapphire substrate after the etching step.

FIG. 9 are views for explaining a degree of reflection obtained from a structure in which fluorescent material fine particles are dispersed in a sealant. (a) of FIG. 9 is a view illustrating a state before and after radiation of incident light. (b) to (e) of FIG. 9 are views respectively illustrating relationships among an area of a spot of laser light, an area of the whole light receiving surface for receiving radiation of excitation light of a light emitting section, and an area of an excited surface of the light emitting section.

FIG. 10 are views for explaining why it is preferable that a heat conductivity of a light emitting section and a heat conductivity of a constituent material of a flank surrounding a periphery of an inlay cavity are similar to each other. (a) of FIG. 10 illustrates a case where there is no heat generation. (b) to (e) of FIG. 10 illustrates cases where excessive heat is generated.

### DESCRIPTION OF EMBODIMENTS

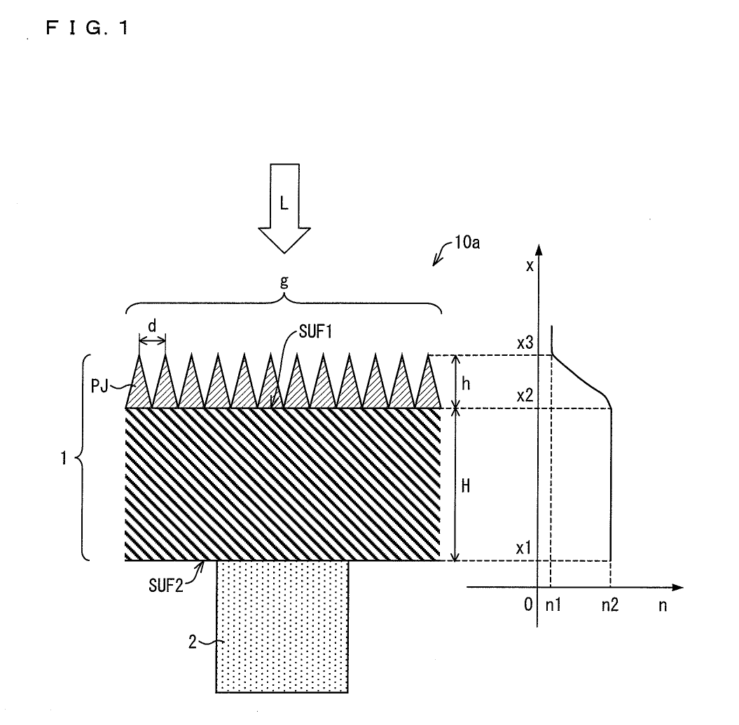

Embodiments of the present invention are described below, referring to FIGS. 1 to 10. The following explanations may describe only configurations to explain therein, omitting description as to the rest of the configurations if not necessary to describe the rest of the configurations. If the omitted configurations have been explained in the other part of this document, the omitted configurations are identical with the configurations described in the other part. Moreover, like member having like functions are labeled in the same manner and their explanations may not be repeated, for the sake of easy explanation.

[1. Configuration of Light Emitting Element 10a]

To begin with, a configuration of a light emitting element 10a according to one embodiment of the present invention is described herein, referring to FIG. 1. FIG. 1 is a cross sectional view schematically illustrating the configuration of the light emitting element 10a and it should be noted that constituent elements shown in FIG. 1 are not illustrated in actual dimensions.

As illustrated in FIG. 1, the light emitting element 10a includes a transparent substrate 1 and a light emitting section 2.

<Transparent Substrate 1>

The transparent substrate 1 of the present embodiment is a member having a flat plate-like shape that is not bent or curved, and is at least transmissive to laser light L (excitation light) of a predetermined wavelength.

Moreover, a surface of the transparent substrate 1 is a light receiving surface SUF 1. On or above the light receiving surface SUF 1, a so-called microstructure g (rough structure) constituted by a plurality of fine projections (protruded parts) PJ is provided. Note that the microstructure g is not limited to the configuration constituted by the plurality of fine projections PJ, which configuration is described in the present embodiment. For example, the microstructure may be constituted by a plurality of fine pores (recessed parts) PH, as described later.

Here, the “protruded parts” are projections PJ extended substantially along a radiation direction of laser light L reversely, like the microstructure g as illustrated in FIG. 1. As one alternative, the “protruded parts” are parts located between recessed parts and locally protruded substantially along the radiation direction of excitation light reversely (the “protruded parts” in this case encompass parts bulged between adjacent fine pores PH). Moreover, the “recessed parts” are fine pores PH deepened substantially along the radiation direction of laser light L forwardly. As one alternative, the “recessed parts” are parts located between protruded parts and locally recessed substantially along the radiation direction of laser light L forwardly (the “recessed parts” in this case encompass parts dented between adjacent projections PJ).

Intervals d between the protrusions PJ (or the fine pores PH) are preferably not less than 5 nm but not more than 3000 nm, or more preferably not less than 5 nm but not more than 1500 nm, so that the intervals can be ones capable of reducing reflection.

If the intervals d are less than 5 nm, it is difficult to form the microstructure g. Here, a width of the projections PJ (protruded parts) along a direction parallel to the light receiving surface SUF 1 is referred to as “protruded part width”. The intervals capable of reducing the reflection is substantially equal to the protruded part width.

As described later, an upper limit of a height h of the projection PJ is preferably 3000 nm. Therefore, if the intervals d exceed 3000 nm, the projection PJ then has an aspect ratio (protruded part height/protruded part width) less than 1, thereby making it difficult to obtain sufficient reduction in degree of reflection. Moreover, it is preferable that the laser light L has a wavelength of not less than 350 nm (nano meter) but not more than 1000 nm.

This is because a florescent material applicable to the light emitting section 2 can be efficiently excited at 350 nm or higher in general.

However, in case where the excitation light source is a semiconductor laser (excitation light source), there is still a difficulty today to provide a semiconductor laser for generating laser light L having a wavelength of less than 350 nm. On the other hand, it is not possible to use laser light L having a wavelength of exceeding 1000 nm in order to efficiently excite a fluorescent material so as to obtain fluorescent light in a visible light range.

Apart from the semiconductor laser, it is possible to use an LED chip suitably as the excitation light source. In case the excitation light source is an LED, it is preferable that the LED chip has a peak wavelength in a vicinity of 450 nm. Meanwhile, the LED chip may have a peak wavelength in a range of 350 nm (inclusive) and approximately 450 nm. The fluorescent material can be excited efficiently at the wavelength in this range, and a small-sized and low-cost LED chip can be used to provide light having a wavelength in this range. Therefore, by using an LED chip for emitting light having a wavelength in this range, it is possible to increase efficiency of the light emitting device and reduce the size and cost of the light emitting device.

Moreover, as to the height h of the projections PJ (i.e., protruded part height along a perpendicular direction with respect to the light receiving surface SUF 1), it is preferable that the height h is not more than 3000 nm. If the height h of the projections PJ exceeds 3000 nm, it becomes difficult to attain reduction in the degree of reflection, and to form the projections PJ. As to features of the microstructure g other than what is described above will be described later.

The transparent substrate 1 has a reverse surface SUF 2 (reverse side), which is opposite to the light receiving surface SUF 1. On the side of the reverse surface SUF 2, the light emitting section 2 is provided. The reverse surface SUF 2 and the light emitting section 2 are thermally connected (that is, so as to be thermally conductive with each other). In the present embodiment, an exemplary configuration in which the transparent substrate 1 and the light emitting section 2 are connected (bonded) with each other via an adhesive agent is described. However, the present invention is not limited to this exemplary configuration, and the transparent substrate 1 and the light emitting section 2 may be connected with each other by fusion.

Moreover, suitable examples of the adhesive agent are so-called organic adhesive agent or a glass paste adhesive agent. However, the adhesive agent is not limited to these.

By configuring the transparent substrate 1 to have the shape described above and be connected with the light emitting section 2 by the configuration described above, the light emitting efficiency of the light emitting section 2 can be improved, and the output efficiency of the yielded fluorescent light outputted from the light emitting section 2 via the transparent substrate 1 can be improved. Moreover, the transparent substrate 1 is configured to firmly fix (hold) the light emitting section 2 by the reverse surface SUF 2, and to be capable of releasing, out of the light emitting element 10a, heat generated by the light emitting section 2. This improves efficiency of cooling the light emitting section 2.

For the sake of efficient heat release from the light emitting section 2, the heat conductivity of the transparent substrate 1 is preferably not less than 20 W/mK (watt/meter·kelvin). In this way, the heat conductivity of the transparent substrate 1 is 20 times higher than that (1 W/mK) of the light emitting section 2. This enables the transparent substrate 1 to efficiently deprive the light emitting section 2 of the heat generated by the light emitting section 2, thereby making it possible to perform efficient heat release for cooling the light emitting section 2.

Moreover, the laser light L incident on the light receiving surface SUF 1 passes through the transparent substrate 1 to the light emitting section 2. Thus, it is preferable that the transparent substrate 1 is made from a material having an excellent translucency.

In view of this, preferable examples of the material of the transparent substrate 1 encompass sapphire (Al₂O₃), magnesia (MgO), gallium nitride (GaN), spinel (MgAl₂O₄). Use of these materials provides the transparent substrate 1 with a heat conductivity of 20 W/mK or higher.

It should be noted that the material of the transparent substrate 1 is not limited to these materials exemplified above. For example, the transparent substrate 1 may be made from glass (quartz) or the like.

Magnesia has a deliquescent property, which would possibly damage the microstructure g. Therefore, if magnesia is selected as the constituent material of the transparent substrate 1, it is necessary to keep the transparent substrate 1 surrounded with dry air. For example, it may be arranged such that the light emitting element 10a is contained in a sealed case (not shown) filled with dry air, or that the light emitting element 10a is contained in a space formed within a parabola-type reflective mirror (reflective mirror) 4 and an optical member 8 or within a half parabola-type reflective mirror (reflective mirror) 4h and an optical member 8, which space is sealed and filled with dry air. These arrangements can prevent the microstructure g from being damaged by the deliquescence.

Moreover, the thickness H of the transparent substrate 1 as illustrated in FIG. 1 (i.e., a distance between the light receiving surface SUF 1 and the opposite surface SUF 2) is preferably not less than 30 μm but not more than 1.0 mm, more preferably not less than 0.2 mm but not more than 1.0 mm.

In comparison with a transmissive type light emitting device (light emitting device) 20 described later, a reflective type light emitting device (light emitting device) 30 described later is greater in heat release effect of the transparent substrate 1. However, if the transparent substrate 1 has a thickness H thinner than 30 μm, the reflective type light emitting device 30 would not be able to secure sufficient heat lease from the light emitting section 2, thereby causing deterioration of the light emitting section 2. This would possibly lead to deterioration of the microstructure g due to the heat generated from the light emitting section 2.

Even in case of the transmissive type light emitting device (light emitting device) 20, the heat release of the light emitting section 2 can be sufficiently performed and thereby the deterioration of the light emitting section 2 can be prevented as long as the transparent substrate 1 has a thickness of 0.2 mm or greater. Further, in such a case, it is possible to prevent the microstructure g from being damaged due to the heat generated from the light emitting section 2.

On the other hand, if the thickness H of the transparent substrate 1 is greater than 1.0 mm, the transparent substrate 1 will absorb a greater amount of the laser L radiated toward the light emitting section 2, thereby causing a significant decrease in use efficiency of the laser light L.

Moreover, by connecting with the light emitting section 2 the transparent substrate 1 having an appropriate thickness H, it is possible to provide prompt and efficient heat release and consequently prevention of damage (deterioration) to the light emitting section 2 even in case where such intensive laser light L as exceeding 1 W.

Note that, as described above, the transparent substrate 1 may be in a flat plate-like shape having no bending or curving as described above, but may be in a shape having a bended portion or a curved portion. However, in case where the transparent substrate 1 and the light emitting section 2 are bonded with each other, it is preferable that a bonding portion of the transparent substrate 1 to which bonding portion the light emitting section 2 is to be bonded has a flat surface (plate-like shape), for the sake of facilitating stable bonding.

(Microstructure g)

Next, the microstructure g is described here. The microstructure g is, more specifically, a rough structure in which a plurality of fine projection PJ or a plurality of fine pores PH are densely arranged with such intervals d that can reduce the reflection of the laser light L from the light receiving surface SUF 1. One well-known example of such a microstructure g is a moth-eye structure. But, the microstructure g herein is not limited to such a moth-eye structure.

As illustrated in FIG. 1, the transparent substrate 1 according to the present embodiment is described as such a transparent substrate that the plurality of projections PJ constituting the microstructure g are densely arranged along the light receiving surface SUF 1 with intervals d smaller than the wavelength of the laser light L. However, it should be noted that in the present invention, the projections PJ or the pores fine PH may be densely arranged along the light receiving surface SUF 1 with intervals d greater than the wavelength of the laser light L, provided that the intervals d are in nano meter order. For example, for light having a wavelength of about 400 nm, intervals d of about 500 nm can be effective to reduce the degree of reflection. With the configuration described above, the degree of reflection of the laser light L from the light receiving surface SUF 1 is reduced.

While only the intervals d in the horizontal direction of the page of FIG. 1 are illustrated in FIG. 1, intervals along a depth direction of FIG. 1 may be defined.

For the sake of easy explanation, the present embodiment is described such that the intervals d along the horizontal direction of the page of FIG. 1 are identical with the intervals along the depth direction of the page of FIG. 1, and that the plurality of projection PJ (or the plurality of fine pores PH) are arranged in dot-matrix with regular intervals on the light receiving surface SUF 1. It should be noted that the present invention is not limited to such a configuration and may be configured such that the intervals d along the horizontal direction of the page of FIG. 1 are different from the intervals along the depth direction of the page of FIG. 1, for example.

Moreover, the microstructure g may be arranged such that the plurality of projection PJ (or the plurality of fine pores PH) are arranged with or without regular intervals. That is, the microstructure g may be arranged such that the plurality of projection PJ (or the plurality of fine pores PH) are arranged along the light receiving surface SUF 1 with non-regular intervals in terms of at least one direction. With such an arrangement, diffraction of the laser light L is prevented in the at least one direction along which the projection PJ (or the fine pores PH) have non-regular intervals. This further reduces the degree R of reflection of the laser light L from the transparent substrate 1.

Moreover, the microstructure g may be arranged such that the plurality of projection PJ (or the plurality of fine pores PH) are arranged with random intervals having almost no regularity. Here, the wording “random” means that the plurality of projection PJ (or the plurality of fine pores PH) are arranged with non-regular intervals in at least two different directions. Randomness is increased as the number of directions in which the plurality of projection PJ (or the plurality of fine pores PH) are arranged with non-regular intervals.

Greater randomness further prevents the generation of the diffraction of the laser light L, thereby further reducing the degree R of reflection of the laser light L from the transparent substrate 1.

Next, the shape of the projections PJ is described. In the example illustrated in FIG. 1, the projections PJ have a circular cone or a pyramid-like shape such as a quadrangular pyramid shape. However, the shape of the projections PJ is not limited to these, and can be various shapes. For example, bell-like shapes (or Tholoide (lava dome) volcano-like shape), Konidee volcano-like shape (composite volcano-like shape), etc. can be some examples of the shape of the projections PJ.

(Preferable Shapes of Microstructure g)

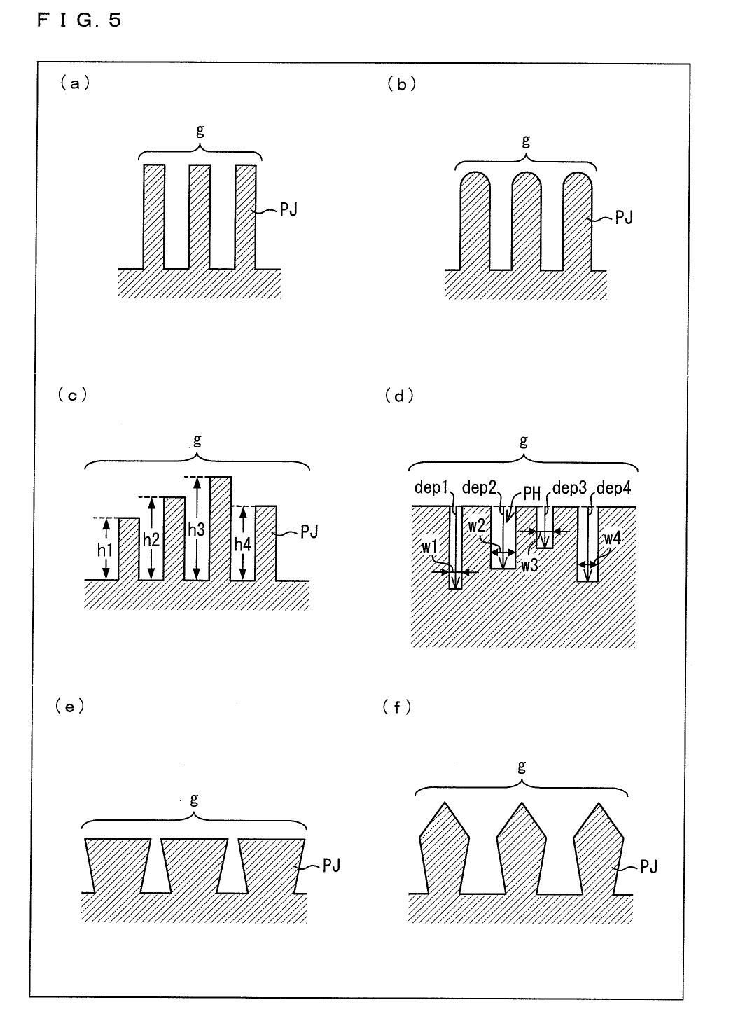

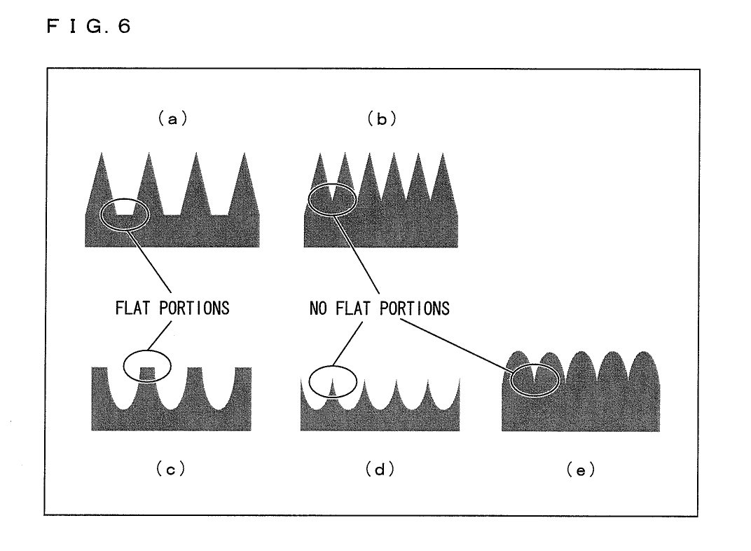

Next, concrete examples of the microstructure g are described, referring to FIGS. 5 and 6.

In an example illustrated in (a) of FIG. 5, a microstructure g has such a shape that projections PJ has a constant diameter from a bottom thereof to a top thereof along a direction perpendicular to the light receiving surface SUF 1.

In an example illustrated in (b) of FIG. 5, a microstructure g has such a shape that projections PJ has a constant diameter from a bottom thereof to a vicinity of a top thereof along a direction perpendicular to the light receiving surface SUF 1, but the projections PJ are tapered to the top thereof from the vicinity of the top by continuously reducing their diameter. Here, the term “continuously” means that the diameter of that cross section of the projections PJ which is parallel to the light receiving surface SUF 1 changes “gradually”, i.e., without a notable “sudden change”, along the direction the projections PJ are extended.

In an example illustrated in (c) of FIG. 5, projections PJ having different protruded part heights h1 to h4 (a length from the bottom to the top of the projections PJ) are provided in array.

In an example of (d) of FIG. 5, the microstructure g is arranged such that it is a group of a plurality of fine pores PH, instead of a plurality of protruded parts. The microstructure g may be a group of a plurality of fine pores PH, as illustrated in (d) of FIG. 5.

In the example illustrated in (d) of FIG. 5, the fine pores PH have different recessed part depths dep 1 to dep 4 along the direction perpendicular to the light receiving surface SUF 1, and different recessed part widths w1 to w4 along the direction parallel to the light receiving surface SUF 1.

Next, in an example illustrated in (e) of FIG. 5, projections PJ continuously become larger in diameter (protruded part width) from the bottom to the top thereof.

In an example illustrated in (f) of FIG. 5, projections PJ continuously become larger in diameter (protruded part width) from the bottom thereof until a certain point before reaching the top thereof, and then continuously become smaller in diameter (protruded part width) from the certain point to the top thereof.

As explained above, the microstructure g can be embodied as having various shapes and is not limited to the shapes illustrated in (a) to (f) of FIG. 5.

For example, as illustrated in FIG. 6, projections PJ may becomes smaller in diameter continuously. (a) to (e) of FIG. 6 illustrate typical examples of such a microstructure g. FIG. 6 are sectional views schematically illustrating exemplary configurations of the microstructure g formed on or above the light receiving surface SUF 1 of the transparent substrate 1.

(a) of FIG. 6 illustrates one exemplary configuration of the microstructure g (cone-like shaped with flat portions). (b) of FIG. 6 illustrates another exemplary configuration of the microstructure g (cone-like shaped without flat portions).

(c) of FIG. 6 illustrates still another exemplary configuration of the microstructure g (Konidee-like shaped with flat portions). (d) of FIG. 6 illustrates yet another exemplary configuration of the microstructure g (icicle-like shaped without flat portions). (e) of FIG. 6 illustrates still yet another exemplary configuration of the microstructure g (bell-like shaped without flat portions).

As illustrated in FIG. 6, the microstructure g may or may not have flat portions between the projections, depending on how the microstructure g is made. Moreover, there are various types of projections such as circular cone-like shapes, quadrangular pyramid-like shapes, and bell-like shapes.

As to the shape of the projections PJ, it is preferable that the shape is one without flat portions, like the ones illustrated in (b), (d), and (e) of FIG. 6. With such flat portions, the prevention of the reflection or the reduction of the reflection would possibly be reduced because the change in the refractive index from air to the material (such as glass or sapphire) occurs “suddenly” rather than “smoothly” at the flat portions.

The plurality of projections PJ having such a shape are arranged densely with the intervals d on the light receiving surface SUF 1, whereby, as illustrated in the graph on the right-hand side of FIG. 1, the refractive index n of the combination of air and the microstructure g changes smoothly (gradually) from a refractive index n1 (at coordinates×3) of the air to a refractive index n2 (at coordinates×2) of the transparent substrate 1, thereby significantly lowering the degree R of reflection of the laser light L from the transparent substrate 1. Note that the refractive index n is, of course, constant and equal to the refractive index n2 of the transparent substrate 1 when x2≦x≦x1. On the other hand, the refractive index n is, of course, constant and equal to the refractive index n1 of the air when x≧x3.

The refractive index n1 of the air can be regarded as being substantially equal to the refractive index of vacuum, and therefore can be regarded as 1. On the other hand, when the transparent substrate 1 is made from sapphire, the refractive n2 is 1.785.

In general, the degree R of reflection (%) of light at a boundary between materials having different refractive indexes n is expressed by the following Equation (1) as follows:

R=[(n1−n2)̂2/(n1+n2)̂2]×100 (1)

where n1 and n2 are the different refractive indexes n of the materials, respectively.

The Equation (1) indicates that the degree R of reflection is smaller for a boundary between materials whose refractive index difference Δn (=|n1−n2|) is smaller, while the degree R of the reflection R is larger for a boundary between materials whose refractive index difference Δn (=n1−n2) is larger. In other words, the degree of reflection of light is dependent on the refractive index difference Δn at the boundary between the materials.

Here, for example, when the laser light L is incident on the transparent substrate 1 having the microstructure g as described above, the refractive index n encountering the laser light L changes smoothly (gradually). Thus, the laser light L travels as if there is no refractive index difference Δn. In other words, the absence of the refractive index difference Δn means that there is no reflection. Thus, the laser light L is hardly reflected from the light receiving surface SUF 1 of the transparent substrate 1. As a result, the radiation efficiency of the laser light L radiated to the light emitting section 2 is improved.

Moreover, when the fluorescent light passing through the transparent substrate 1 goes out into the air from the light receiving light surface SUF 1, the fluorescent light can be outputted with good output efficiency into the air from the transparent substrate 1 because there is substantially no refractive index difference Δn at the boundary as in the case of the laser light L. That is, the output efficiency of the fluorescent light into the air from the transparent substrate 1 is improved.

For example, an ordinary flat boundary between sapphire and air causes a 7.9% surface reflection. The surface reflection can be reduced substantially 0% by the microstructure g provided on the light receiving surface SUF 1 of the transparent substrate 1 made from sapphire.

Further, the light receiving surface SUF 1 and the reverse surface SUF 2 which is the reverse side of the light receiving surface SUF 1 are distanced from each other by the thickness H of the transparent substrate 1. In other words, the boundary between the air and the transparent substrate 1, that is, a refractive index boundary from which the laser light L enters the transparent substrate 1 and at which the refractive index difference Δn is normally large but is reduced by the microstructure, is distanced from a thermal boundary to which the heat from the light emitting section 2 which is a greatest heat source among constituent elements of the light emitting element is conducted to the transparent substrate 1. By this, the microstructure g can be protected from the heat generated from the light emitting section 2. Thus, the function of the light emitting element 10a of the present embodiment can be maintained for a long time.

All the materials specifically exemplified as the material of the transparent substrate 1 in the present embodiment have high melting points: sapphire (melting point: 2050° C.), magnesia (melting point: 2850° C.), gallium nitride (melting point: at lest 1000° C. or higher), spinel (melting point: 2130° C.). Such high melting points make it possible for the transparent substrate 1 to maintain its initial shape, even if the light emitting section 2 heated to a high temperature by the radiation of the laser light L.

<Light Emitting Section 2>

(Composition of Light Emitting Section 2)

The light emitting section 2 is configured to generate fluorescent light by receiving radiation of the laser light L. The light emitting section 2 includes a fluorescent material for generating fluorescent light upon receiving the laser light L. More specifically, the light emitting section 2 is configured such that the fluorescent material is dispersed inside a sealant, which is inorganic glass having a low melting point (and having n=1.760).

A ratio between the inorganic glass and the fluorescent material is, for example, approximately 10:1. It should be noted that the present invention is not limited to the ratio. Moreover, the light emitting section 2 may be one prepared by hardening the fluorescent material by pressing.

The sealant is not limited to the inorganic glass exemplified in the present embodiment, and may be so-called organic-inorganic hybrid glass or a resin material such as silicone resin.

Next, it is preferable that the refractive index difference Δn between the transparent substrate 1 and the light emitting section 2 is 0.35 or less.

In case the sealant is a resin material such as silicone resin, the refractive index n of the light emitting section 2 is about 1.5 (lower limit). In case the light emitting section 2 is made 100% from an oxynitride fluorescent material, the light emitting section 2 has a refractive index n of about 2.0.

On the other hand, in case the transparent substrate 1 is made from sapphire, magnesia, gallium nitride, or spinel, the refractive index n of the transparent substrate 1 is approximately in a range of 1.5 to 2. If it is supposed that the refractive indexes n of the light emitting section 2 and the transparent substrate 1 are both approximately in a range of 1.5 to 2.0, the degree R of reflection at the boundary between the light emitting section 2 and the transparent substrate 1 can be 1% when the refractive index difference Δn is 0.35 where one of the refractive indexes n is 1.5 (that is, the other one of the refractive indexes n is 1.85).

Moreover, the degree R of reflection at the boundary between the light emitting section 2 and the transparent substrate 1 can be 0.92% when the refractive index difference Δn is 0.35 where one of the refractive indexes n is 2.0 (that is, the other one of the refractive indexes n is 1.65).

Therefore, if the refractive index difference Δn between the light emitting section 2 and the transparent substrate 1 is 0.35 or less, the degree R of reflection at the boundary between the light emitting section 2 and the transparent substrate 1 can be 1% or less.

Next, the refractive index n of the transparent substrate 1 is preferably 1.65 or greater. As described above, if the upper limit of the refractive index n of the light emitting section 2 is 2.0, the refractive index difference Δn≦0.35 can be satisfied for the light emitting section 2 having a refractive index n in a range of 1.5 to 2.0, provided that the refractive index n of the transparent substrate 1 is 1.65 or greater.

The reason why the inorganic glass is used as the sealant of the light emitting section 2 is that the inorganic glass has a refractive index n (=1.760) very close to the refractive index n2 (=1.785), so the reflection hardly occurs at their boundary. The degree of reflection at the boundary between the sapphire and the inorganic glass is 0.005%, which is substantially 0%.

Therefore, in the light emitting element 10a, the combination of the transparent substrate 1 (sapphire) having the aforementioned microstructure g and the light emitting section 2 (inorganic glass:fluorescent material=10:1) allows the laser light L to reach the light emitting section 2 with degree of reflection being kept at substantially 0% from the air to the light emitting section 2 via the transparent substrate 1. Thus, the radiation efficiency of the laser light L radiated to the light emitting section 2 is further improved. Moreover, the fluorescent light reaches a top surface portion (a surface including the top of the projections PJ) of the microstructure g with degree of reflection being kept at substantially 0% from the reverse surface SUF 2 facing the light emitting section 2 to the top surface portion of the microstructure g. Therefore, the output efficiency of the fluorescent light traveling from the light emitting section 2 via the transparent substrate 1 is also further improved.

Physical properties of the sapphire used for the transparent substrate 1 and the inorganic glass used for the light emitting section 2 in the present embodiment are summarized in the following Table 1.

TABLE 1

| | Transparent | Light Emitting |
|---|---|---|
| | substrate 1 | Section 2 |
| Material | Sapphire (Al₂O₃) | Inorganic Glass |
| Heat Conductivity (W/mK) | 25 (at 100° C.) | 1 |
| Refractive index | 1.785 | 1.760 |
| Thickness (mm) | 0.2 to 1 | 0.5 to 2.0 |
| Melting Point (° C.) | 2050 | <1000 |
| Heat Resistance (K/W) | 0.2 | 83.3 |

(Fluorescent Material)

The fluorescent material included in the light emitting section 2 is, for example, an oxynitride fluorescent material and/or a nitride fluorescent material, and at least one type of fluorescent materials emitting blue, green and red light respectively is dispersed in the inorganic glass.

For example, if the later described laser light source (excitation light source, semiconductor laser 3) is a semiconductor laser having an excitation wavelength of 405 nm (bluish purple), the fluorescent light generated from the light emitting section is white light as a result of mixing the multi colors.

Moreover, the fluorescent material may be a mixture of red fluorescent material and green or yellow fluorescent material. The yellow fluorescent material is a fluorescent material emitting fluorescent light having a peak wavelength in a wavelength range between 560 nm and 590 nm inclusive. The green fluorescent material is a fluorescent material emitting fluorescent light having a peak wavelength in a wavelength range between 510 nm and 560 nm inclusive. The red fluorescent material is a fluorescent material emitting fluorescent light having a peak wavelength in a wavelength range between 600 nm and 680 nm inclusive.

(Kinds of Fluorescent Materials)

It is preferable that the light emitting section 2 includes the oxynitride fluorescent material and/or the nitride fluorescent material, and/or a III-V group semiconductor nano particle fluorescent material. These materials are highly tolerant against a very intensive laser light (high output and high power density).

One typical example of the oxynitride fluorescent material is a so-called sialon fluorescent material. The sialon fluorescent material is a material in which part of silicon of silicon nitride is substituted with aluminum and part of nitrogen is substituted with oxygen. The sialon fluorescent material can be produced by preparing a solid solution in which alumina (Al₂O₃) and quart (SiO₂), and a rare earth element, for example, is mixed in silicon nitride (Si₃N₄).

Meanwhile, one of features of the semiconductor nano particle fluorescent material is its capability of changing a color of its emitted light by quantum size effect caused by changing its particle diameter to a nano meter size while still using the same compound semiconductor (e.g., indium phosphate: InP). For example, InP emits red light when it has a particle size of 3 to 4 nm (which particle size was evaluated by transmission electron microscope (TEM)).

The semiconductor nano particle fluorescent material is short in its fluorescence life because it is based on a semiconductor, while the semiconductor nano particle fluorescent material is tolerant against excitation light of high power and high power density because the semiconductor nano particle fluorescent material can quickly convert the power of the excitation light into fluorescent light emission. These features of the semiconductor nano particle fluorescent material is due to such a short emission lifetime (10 ns (nano seconds)) of the semiconductor nano particle fluorescent material in comparison with ordinary fluorescent materials whose emission center is a rare earth. The emission lifetime of the semiconductor nano particle fluorescent material is shorter than that of the ordinary fluorescent materials by 5 digits.

Further, as described above, the short emission lifetime makes it possible to repeat the absorption of the laser light L and the light emission of the fluorescent material quickly. As a result, it is possible to maintain a high efficiency even in case the laser light L is intensive laser light. This can reduce the heat generation from the fluorescent material.

Thus, the thermal deterioration (color change, deformation, quality change, etc.) of the light emitting section 2 can be further prevented. By this, it becomes possible to further prevent shortening of the life of the light emitting element 10a in case the excitation light source is a light emitting element outputting intensive excitation light.

(Shape and Size of Light Emitting Section 2)

As to a shape and a size, the light emitting section 2 has, for example, a circular cylinder shape having a diameter of 2.0 mm and a thickness of 1 mm. Moreover, the light emitting section 2 may have a rectangular shape rather than a circular cylinder shape. For example, the light emitting section 2 may have a rectangular shape having a size of 3 mm×1 mm×1 mm.

How thick the light emitting section 2 should be here is depended on a ratio of the fluorescent material and the sealant in the light emitting section 2. An increase in fluorescent material content ratio in the light emitting section 2 increases an efficiency of converting the laser light L into white light until the fluorescent material content ratio reaches a certain level. Thus, the increase in fluorescent material content ratio in the light emitting section 2 allows thinning the thickness of the light emitting section 2. A thinner thickness of the light emitting section 2 brings about a greater heat release effect to release heat to the transparent substrate 1. However, excessively thin thickness of the light emitting section 2 would possibly lead to such a problem that the laser light L is not converted to fluorescent light but is emitted outside instead. For the sake of causing the fluorescent material to absorb the laser light L, the light emitting section 2 preferably has a thickness of 10 times or greater than the particle diameter of the fluorescent material. The thickness of the light emitting section 2 using the nano particle fluorescent material can be 0.01 μm at thinnest to satisfy this requirement. However, in further consideration of easy production process, such as dispersing into the sealant, the thickness of the light emitting section 2 is preferably not less than 10 μm, that is, not less than 0.01 mm.

Therefore, it is preferable that the thickness of the light emitting section 2 is not less than 0.2 mm but not more than 2 mm, when an oxynitride fluorescent material or nitride fluorescent material is used. The lower limit of the thickness may be different from the above, if the light emitting section 2 has a fluorescent content ratio extremely high (typically 100% fluorescent content ratio).

Moreover, apart from the size and shape of the light emitting section 2 described above, the light emitting section 2 may have, for example, a 10 mm×10 mm square bottom shape with a 0.3 mm thickness. By configuring such a light emitting section 2 to be radiated with, for example, laser light L having a diameter of 1 mm or 2 mm as the excitation light, it is also possible to realize a light emitting section 2 having high brightness and high flux of light.

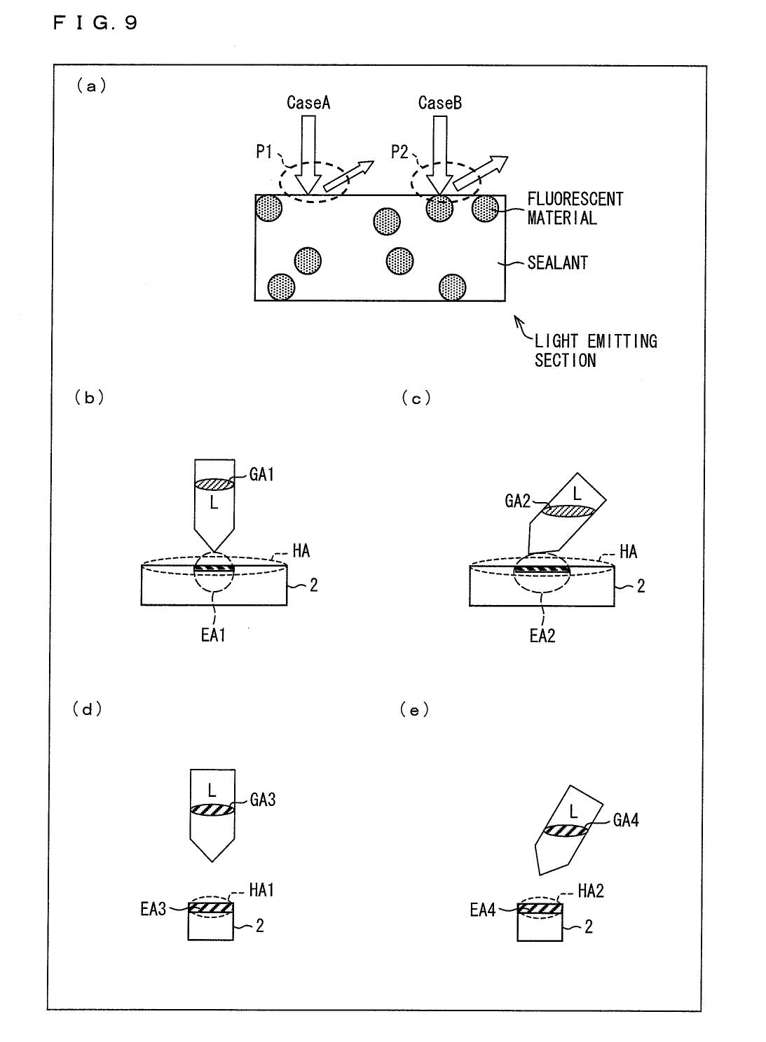

The reason why such a light emitting section 2 having high brightness and high flux of light can be obtained by giving the light emitting section 2 the size and shape, referring (b) to (e) of FIG. 9 It should be noted that the transparent substrate 1 is not illustrated in FIG. 9.

(b) and (c) of FIG. 9 illustrate cases where a whole area of an incident surface HA of the light emitting section 2 is wider than each of an area of a spot GA1 (incident angle=0° and an area of a spot GA 2 (0°<incident angle<90°), wherein the incident surface HA is a surface which the laser light L enter, the spot GA1 is cross sections of a beam of the laser light L being incident to the incident surface HA at an incident angle=0° and being cross-sectioned in parallel with the incident surface HA, while the spot GA2 is cross sections of a beam of the laser light L being incident to the incident surface HA at an incident angle>0° but <90° and being cross-sectioned in parallel with the incident surface HA.

In (b) and (c) of FIG. 9, areas of excitation surfaces EA1 and EA2 are each smaller than the whole area of the incident surface HA.

For example, in case where the whole area of the incident surface HA of the light emitting section 2 on which incident surface HA the laser light L is incident is 10 mm×10 mm and the spots GA1 and GA2 are equal to areas of 1 mm diameter and 2 mm diameter circles (regarding the oval shape is a circle) respectively, the states illustrated in (b) and (c) of FIG. 9 are obtained.

In this case, in the light emitting section 2, the excitation surfaces EA1 and the EA2, which are actually irradiated, have the areas approximately equal to the 1 mm diameter and 2 mm diameter circles, respectively. Exciting the areas of such sizes is enough to obtain sufficient flux of light.

Therefore, even if the whole area of the incident surface HA of the light emitting section 2 is large, the light emitting section 2 can have a high brightness when the respective areas of the excitation surfaces EA1 and EA2 (actually shining portions) are minute.

On the other hand, (d) and (e) of FIG. 9 illustrate cases where the whole areas of the incident surface HA1 and HA2 of the light emitting section 2, which incident surface HA1 and HA2 the laser light L is incident are equal to spots GA3 and GA4, respectively.

In (d) and (e) of FIG. 9, areas of the incident surface HA1 and HA2 are equal to areas of excitation surfaces EA3 and EA4, respectively.

The states illustrated in (d) and (e) of FIG. 9 are obtained, for example, when the whole area of the incident surface HA of the laser light L of the light emitting section 2 is equal to the areas of the 1 mm diameter circles or the 2 mm diameter circle, and the areas of the spots GA3 and GA4 are equal to the 1 mm diameter circle and the 2 mm diameter circle (regarding the oval shape as a circle), respectively.

In this case again, the areas of the excitation surfaces EA3 and EA4, which are actually radiated, of the light emitting section 2 are equal to the approximately 1 mm diameter and 2 mm diameter circles, respectively. By exciting such areas, it is possible to obtain sufficient flux of light. That is, when the areas of the excitation surfaces EA3 and EA4 are minute, the light emitting section 2 has a high brightness.

As described above, the light emitting section 2 has a high brightness as long as the areas of the excitation surfaces EA1 to EA4 are minute, regardless of how large the incident angle of the excitation light and the whole areas of the incident surfaces HA, HA1, and HA2 are. Based on this concept, a light emitting section 2 having a high brightness and high flux of light can be realized by giving the light emitting section 2 the size and shape described above.

[2. Configuration of Light Emitting Element 10b]

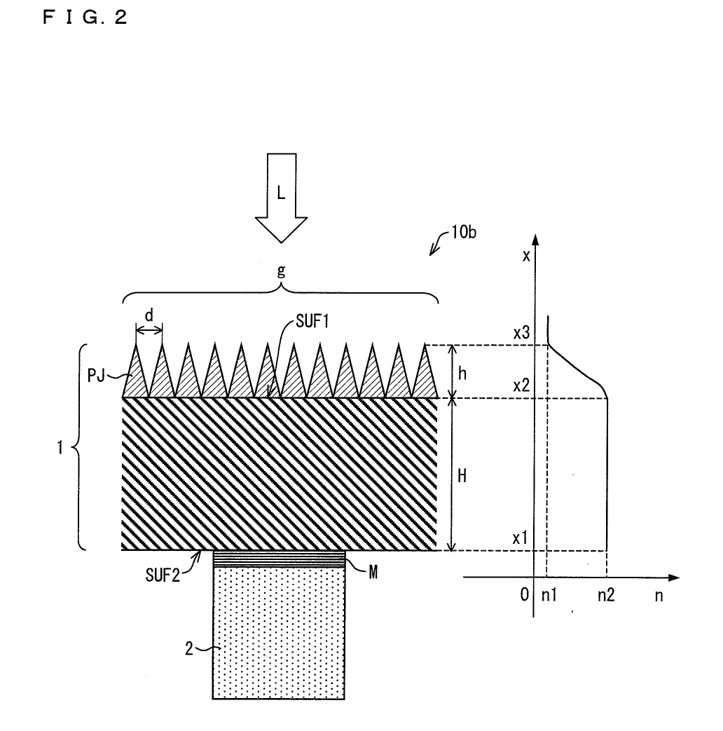

Next, a configuration of a light emitting element 10b according to another embodiment of the present invention is described below, referring to FIG. 2, which is a cross sectional view schematically illustrating the configuration of the light emitting element 10b.

In the light emitting section 10a, the light emitting section 2 is connected (bonded) with the transparent substrate 1. However, the light emitting section 10b according to the present embodiment is different from the light emitting section 10a in that, a light transmissive layer M is provided between a transparent substrate 1 and the light emitting section 2, as illustrated in FIG. 2. Except the light transmissive layer M, the light emitting section 10b is identical with the light emitting section 10a, and explanation on other configurations of the light emitting section 10b than the light transmissive layer M is omitted here.

It may be interpreted in a strict sense that the light emitting section 10a and the light emitting section 10b are identical in terms of configuration if the layer (adhesive agent layer) constituted by the particular adhesive agent bonding the transparent substrate 1 and the light emitting section 2 together is considered as corresponding to the light transmissive layer M.

The light transmissive layer M is not particularly limited, provided that it is transmissive to the laser light L and to the fluorescent light generated by the light emitting section 2.

For example, as in the light emitting element 10a, the light transmissive layer M may be an adhesive agent layer.

Apart from the adhesive agent layer, the light transmissive layer M may be a vapor deposition layer, or a transparent material layer made from a transparent resin material.

[3. Configuration of Transmissive Type Light Emitting Device 20]

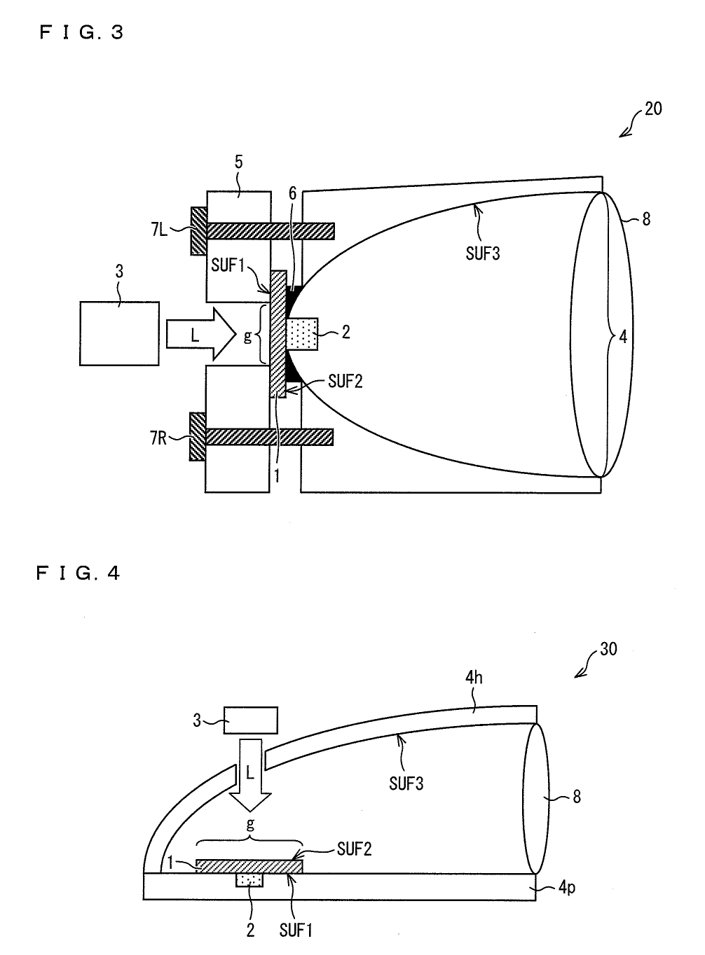

A transmissive type light emitting device (light emitting device) 20 according to still another embodiment of the present invention is described below, referring to FIG. 3, which is a cross sectional view illustrating a configuration of the transmissive type light emitting device 20.

As illustrated in FIG. 3, the transmissive type light emitting device 20 includes, a transparent substrate 1 as described above, a light emitting section 2 as described above, a laser light source (excitation light source) 3, a parabola reflective mirror (reflective mirror) 4, a substrate 5, a metal ring 6, a screws 7L and 7R, and an optical member 8. The transparent substrate 1 and the light emitting section 2 are as described above, so their explanation is not repeated here.

(Laser Light Source 3)

The laser light source 3 is configured to function as an excitation light source for generating excitation light. The laser light source 3 includes a plurality of semiconductor lasers (excitation light sources) on a substrate. The plurality of semiconductor lasers each emits laser light as the excitation light. It is not necessary to use a plurality of semiconductor lasers as the excitation light sources, and it is possible to use a single semiconductor laser as the excitation light source. However, laser light L having a high power can be more easily obtained by using a plurality of semiconductor lasers.

Moreover, semiconductor lasers are small in size. Therefore, the use of the semiconductor lasers to constitute the laser light source 3 makes it possible to further miniaturize the light emitting device including the laser light source 3 and the light emitting section 2, and further to give a greater degree of freedom as to varieties and designing of products to which the light emitting device is applied.

The semiconductor laser has a single light emitting point on one chip. For example, the semiconductor laser is configured to generate laser light of 405 nm (bluish purple, which is a wavelength of the excitation light) with output power of 1.0 W, operational voltage of 5 V, and ampere of 0.6 A, and is sealed in a package of 5.6 mm diameter. The laser light generated by the semiconductor laser is not limited to the laser light of 405 nm but may be any laser light having its peak wavelength in a range of not less than 350 nm and not more than 470 nm.

If a short-wavelength semiconductor laser for generating laser light having a wavelength smaller than 350 nm can be produced with good quality, it is possible that the semiconductor laser of the laser light source 3 according to the present embodiment is such a semiconductor laser designed to generate laser light having a wavelength smaller than 350 nm.

The laser light source 3 according to the present embodiment is constituted by the semiconductor lasers, but may be constituted by a laser light source other than semiconductor lasers. Examples of the laser light source other than semiconductor lasers encompass gas lasers utilizing energy levels of atoms, ions, molecules of gases, etc., liquid lasers using alcoholic solutions of dye molecules, which are organic pigment molecules, and solid lasers utilizing solid crystals including ions causing induced emission, and the like lasers.

Moreover, by using the laser light source other than semiconductor lasers, it is possible to obtain laser light L having very high power with very high power density, thereby making it possible to output the illumination light having high brightness and high flux of light from the light emitting section 2. Moreover, the microstructure g is not damaged by the heat from the light emitting section 2 by distancing the refractive index boundary to which the laser light L is incident and at which the microstructure g is formed, and the thermal boundary to which the heat generated from the light emitting section 2, which is the greatest heat source among the constituent elements of the light emitting element 10a or 10b, is conducted to the transparent substrate 1.

In the present embodiment, the excitation light source is the semiconductor laser. However, it is possible to use a LED chip (light emitting diode) instead of the semiconductor laser. Because LED chips are small in size, the use of the LED chip as the excitation light source makes it possible to miniaturize the light emitting device including the LED chip and the light emitting section 2, and further to give a greater degree of freedom as to varieties and designing of products to which the light emitting device is applied. Moreover, the refractive index boundary to which the excitation light is incident and on which the microstructure g is formed is distanced from the thermal boundary to which the heat from the light emitting section 2 which is the greatest heat source among constituent elements of the light emitting element 10a or 10b is conducted to the transparent substrate 1. Thereby, the heat generated by the excited fluorescent material is released to the transparent substrate 1, thereby lowering an environmental temperature of the fluorescent material. This prevents reduction in efficiency of the light emitting section 2, which reduction is caused by the increase in environmental temperature of the fluorescent material. This contributes further miniaturization and lower power consumption of the light emitting device.

(Parabola Reflective Mirror 4)

Next, the parabola reflective mirror 4 has a light reflective concave surface SUF 3 for reflecting the fluorescent light generated from the light emitting section 2. By reflecting the fluorescent light generated from the light emitting section 2, the parabola reflective mirror 4 forms a bundle of light rays traveling within predetermined solid angles.

The shapes of the light reflective concave surface SUF 3 in the present embodiment is a so-called paraboloid of revolution. Therefore, as illustrated in FIG. 3, the light reflective concave surface SUF 3 has a parabola cross section when cross sectioned along a plane including its optical axis (rotational axis).

Moreover, at a bottom of the paraboloid of revolution of the reflective concave surface SUF 3, an insertion hole (not illustrated) is formed. The light emitting section 2 is inserted inside the insertion hole.

There is no particular limitation as to which material the parabola reflective mirror 4 is made from. In consideration of a reflectivity of the parabola reflective mirror 4, it is preferable that the parabola reflective mirror 4 is prepared by producing a reflective mirror from copper or SUS (Stainless Steel) and then treating the reflective mirror with silver plating, chromate coating, or the like. Apart from this method, the parabola reflective mirror 4 may be produced by producing a mirror with aluminum and then coating the mirror with an anti-oxidation film. Further, the parabola reflective mirror 4 may be produced by forming a metal thin film on a mirror body made of resin.

(Substrate 5)

Next, the substrate 5 is a plate-like member having an opening through which the laser light L emitted from the laser light source 3. To the substrate 5, the parabola reflective mirror 4 is fixed by the screws 7L and 7R. Between the parabola reflective mirror 4 and the substrate 5, the transparent substrate 1 and the metal ring 6 are provided. The metal ring 6 has an opening at its bottom (not illustrated). The opening of the substrate and the opening of the metal ring 6 are aligned such that their centers are substantially matched. Therefore, the laser light L generated from the laser light source 3 passes through the opening of the substrate 5, enters the light receiving surface SUF 1, having the microstructure g, of the transparent substrate 1, travels through inside of the transparent substrate 1, and passes through the opening of the metal ring 6 so as to reach the light emitting section 2.

By this, the laser light L travels through the inside of the light emitting section 2. The fluorescent particles included in the light emitting section 2 scatters the laser light L through the inside of the light emitting section 2 and to the outside of the inside of the light emitting section 2, thereby the laser light L is scattered inside of the parabola reflective mirror 4.

There is no particular limitation as to which material the substrate 5 is made from. If the substrate 5 is made from a metal having a high heat conductivity, the substrate 5 can function as a cooling section for cooling the transparent substrate 1. As illustrated in FIG. 3, the transparent substrate 1 is in touch with the substrate 5 by its whole surface. Thus, if the substrate 5 is made from a metal such as iron, copper, or the like, it is possible to achieve better cooling effect to the transparent substrate 1, and consequently to the light emitting section 2.

(Metal Ring 6)

Next, the metal ring 6 is a ring having a mortar-like shape resemble to a shape of the parabola reflective mirror 4 which shape the parabola reflective mirror 4 has at a vicinity of a focal point that the parabola reflective mirror 4 supposes to have when the parabola reflective mirror 4 is a perfect reflective mirror. The metal ring 6 has a shape of a mortar having an opening at its bottom. The light emitting section 2 is provided in the opening at the bottom of the metal ring 6.

A surface of a mortar-shaped portion of the metal ring 6 functions as a reflective mirror. By combining the metal ring 6 and the parabola reflective mirror 4, a perfect parabola-shape mirror can be formed. Therefore, the metal ring 6 is a reflective mirror portion functioning a part of the perfect reflective mirror. When the parabola reflective mirror 4 is referred to as a first reflective mirror portion, the metal ring 6 may be referred to as a second reflective mirror portion being located at the vicinity of the focal point. Part of the fluorescent light generated from the light emitting section 2 is reflected at the surface of the metal ring 6, and outputted toward a front side of the transmissive type illuminating section 20 (toward the right-hand side of the page of FIG. 3).

There is no particular limitation as to which material the metal ring 6 is made from. In consideration of heat releasing property, it is preferable that the metal ring 6 is made from silver, copper, aluminum, or the like. If the metal ring 6 is made from silver or aluminum, it is preferable that, after mirror-finishing of the mortar-shaped portion, the metal ring 6 is coated with a protective layer (chromate coating or a resin layer) for preventing surface blackening or for anti-oxidation. Moreover, if the metal ring 6 is made from copper, it is preferable that, after silver plating or aluminum vapor deposition, the metal ring 6 is coated with the protective layer.

It is preferable that the metal ring 6 is firmly fixed to the transparent substrate 1. A pressure is caused by fixing the substrate 5 and the parabola reflective mirror 4 by using the screws 7L and 7R. This pressure can fix the metal ring 6 to the transparent substrate 1 to some extent. However, the metal ring 6 can be firmly fixed to the transparent substrate 1, for example, by bonding the metal ring 6 to the transparent substrate 1, by screwing down the metal ring 6 to the substrate 5 with the transparent substrate 1 between them, or the like method. By firmly fixing the metal ring 6 to the transparent substrate 1, it is possible to avoid a risk that the light emitting section 2 is separated off as a result of movement of the metal ring 6.

The metal ring 6 is not particularly limited, provided that it has a function of the reflective mirror portion, and is tolerant against the pressure caused by fixing the parabola reflective mirror 4 and the substrate 5 by using the screws 7L and 7R. The metal ring 6 can be substituted with a non-metal ring. For example, the metal ring 6 can be substituted with a resin ring being tolerant against the pressure and having a metal thin film on its surface.

(Optical Member 8)

The optical member 8 is provided at an opening of the light reflective concave surface SUF 3 of the parabola reflective mirror 4. The optical member 8 seals the transmissive type light emitting device 20. The fluorescent light generated from the light emitting section 2 or reflected from the parabola reflective mirror 4 is outputted toward a front side of the transmissive type light emitting device 20 via the optical member 8.

The optical member 8 has a convex-lens shape and has a lens function in the present embodiment. However, the optical member 8 may have a concave-lens shape, instead of the convex-lens shape. Moreover, the optical member 8 may not have a lens function, provided that the optical member 8 is at least transmissive to the fluorescent light generated from the light emitting section 2 or reflected from the light reflective concave surface SUF 3.

There is no particular limitation as to which material the optical member 8 is made from, provided that the material is at least light transmissive. However, it is preferable that the material has a high heat conductivity (20 W/mK or greater), as in the transparent substrate 1. For example, the optical member 8 preferably includes sapphire, gallium nitride, magnesia, or diamond. In this case, the optical member 8 has a higher heat conductivity than the light emitting section 2. This enables the optical member 8 to efficiently deprive the light emitting section 2 of the heat generated by the light emitting section 2, thereby making it possible to perform efficient heat release for cooling the light emitting section 2.

It is preferable that a thickness of the optical member 8 is, approximately, not less than 0.3 mm but not more than 3.0 mm. If the thickness is thinner than 0.3 mm, the optical member 8 does not has a sufficient strength to withstand against a force applied thereon in fixing the light emitting section 2 and the metal ring 6 to the opening of the light reflective concave surface SUF 3 of the parabola reflective mirror 4. If the thickness is thicker than 3.0 mm, absorption of the radiation light by the optical member 8 becomes no longer ignorable, and cost of the optical member 8 is increased to an unfavorable level.

Moreover, it is preferable that the optical member 8 is formed from a material not transmissive to the laser light L from the laser light source 3 but transmissive to the fluorescent light generated from the light emitting section 2 or reflected from the light reflective concave surface SUF 3.

Most of the coherent laser light L entering the light emitting section 2 is converted into incoherent fluorescent light. However, there is a possibility that part of the coherent laser light L is not converted from any cause. Even in such a case, the optical member 8 not transmissive to the laser light L will not allow the laser light L to pass through, thereby preventing the laser light L from leaking outside.

[4. Configuration of Reflective Type Light Emitting Device 30]

A reflective type light emitting device 30 according to yet another embodiment of the present invention is described below, referring to FIG. 4, which is a cross sectional view schematically illustrating a configuration of the reflective type light emitting device 30.

As illustrated in FIG. 4, the reflective type light emitting device 30 includes a transmissive substrate 1 as described above, a light emitting section 2 as described above, a laser light source 3 as described above, a half-parabola reflective mirror 4h, a heat conduction member 4p, and an optical member 8 as described above.

Apart from what is to be described in the present embodiment, the reflective type light emitting device 30 is identical with the embodiments described above. Therefore, only the half-parabola reflective mirror 4h and the heat conduction member 4-p are explained here.

<Half-Parabola Reflective Mirror 4h>

The half-parabola reflective mirror 4h is identical with the aforementioned parabola reflective mirror 4, except that the half-parabola reflective mirror 4h has a shape obtained by halving the parabola reflective mirror 4 along a plane including the optical axis (rotational axis).

<Heat Conduction Member 4p>

As illustrated in FIG. 4, the heat conduction member 4p has an inlay cavity (not illustrated) for inlaying the light emitting section 2. One side of the light emitting section 2 is inlayed in the inlay cavity while the other side of the light emitting section 2 is connected with the transparent substrate 1. By this, the light emitting section 2 is inlayed inside the inlay cavity of the heat conduction member 4p so as to surround the light emitting section 2 with the transparent substrate 1 and the heat conduction member 4p, thereby improving the cooling effect of the light emitting section 2.

Note that the light emitting section 2 is thermally connected with the heat conduction member 4p. As to a material and a method for the thermal connection, for example, the light emitting section 2 and the heat conduction member 4p may be connected with each other via a heat conductive grease, or a light emitting section 2 in which the fluorescent material is dispersed in inorganic glass serving as a dispersion medium may be produced by connecting the inorganic glass to the heat conduction member 4p by utilizing a property of the inorganic glass that the inorganic glass can be fused to metal.

Next, there is no particular limitation as to which constituent material the heat conduction member 4p is made from, provided that the constituent material is heat conductive to diffuse the heat generated from the light emitting section 2. It is preferable that the heat conduction member 4p is made from a metal or ceramics.

A metal has a high heat conductivity and it is expected that such a metal gives the heat conduction member 4p a heat release effect.

Moreover, for example, in case where the transparent substrate 1 is made from glass or sapphire, the use of ceramics as the constituent material of the heat conduction member 4p can prevent the transparent substrate 1 from being separated from the inlay cavity (i.e., from being thermally insulated by being thermally separated off) as a result of repeated expansion and shrinkage of the light emitting section 2 repeatedly heated by repeated radiation to the light emitting section 2. The use of ceramics as the constituent material of the heat conduction member 4p can do so because the ceramics, glass, and sapphire have similar coefficients of thermal expansion. Moreover, for example, the light emitting section 2 is made from inorganic glass or oxynitride fluorescent material or nitride fluorescent material, the use of ceramics as the constituent material of the heat conduction member 4p can prevent the transparent substrate 1 from being separated from the inlay cavity (i.e., from being thermally insulated by being thermally separated off) as a result of repeated expansion and shrinkage of the light emitting section 2. The use of ceramics as the constituent material of the heat conduction member 4-p can do so again because the ceramics, inorganic glass, and oxynitride fluorescent material or nitride fluorescent material have similar coefficients of thermal expansion.

Next, the laser light L passing through inside the light emitting section 2 is reflected from a bottom surface of the inlay cavity in the heat conduction member 4p. Thus, the laser light L has a double light path length inside the light emitting section 2. By this, it is possible to obtain sufficient light emitting efficiency even when the light emitting section 2 with a certain concentration of the fluorescent material is halved in thickness in the radiation direction of the laser light L.

It is preferable that a material constituting a side wall around the inlay cavity has a coefficient of thermal expansion similar to that of the light emitting section 2.

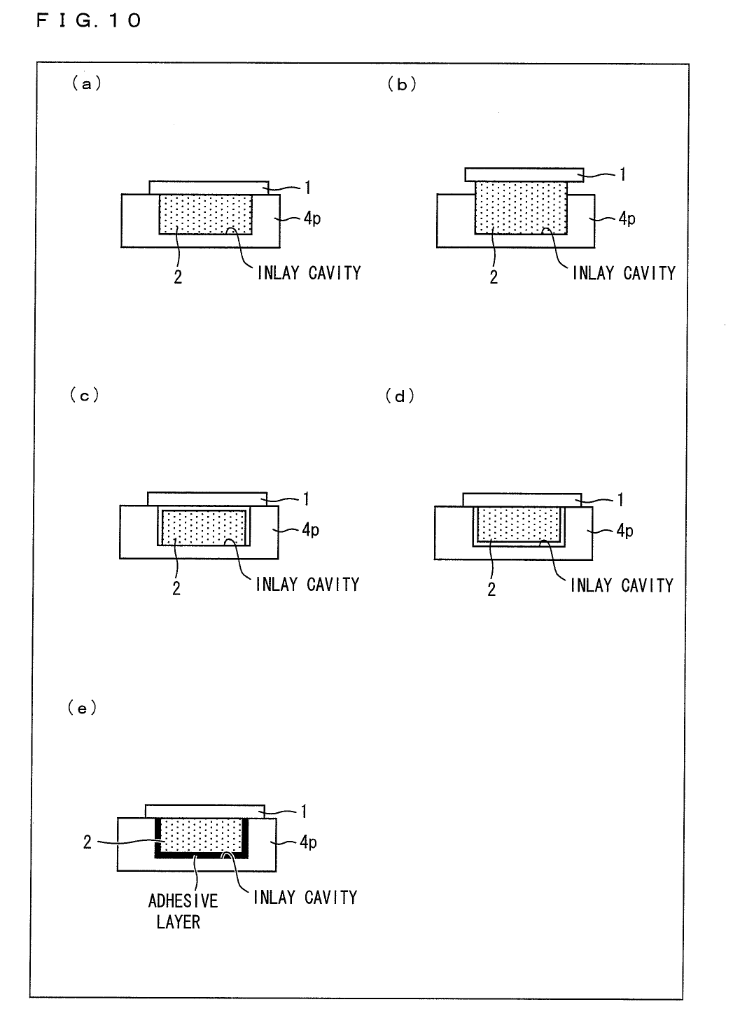

The reason for the above preferable configuration is explained below, referring to FIGS. 10 (a) to (e). (a) of FIG. 10 illustrates a case where no heat is generated. (b) to (d) of FIG. 10 illustrate case where excess heat is generated.

The state illustrated in (b) of FIG. 10 would occur where the light emitting section 2 has a coefficient of thermal expansion greater than that of the material of the side wall of the inlay cavity. On the other hand, the state illustrated in (c) or (d) of FIG. 10 would occur where the light emitting section 2 has a coefficient of thermal expansion smaller than that of the material of the side wall of the inlay cavity.

In the state illustrated in (b) of FIG. 10, the thermal expansion of the light emitting section 2 in the horizontal and depth directions of the page of FIG. 10 merely results in outward force application against the side wall of the inlay cavity, meanwhile the thermal expansion of the light emitting section 2 in the vertical direction of the page of FIG. 10, however, lifts up the transparent substrate 1 even though the transparent substrate 1 is fixed to the peripheral portion of the inlay cavity via the adhesive agent or the like. When the transparent substrate 1 is lifted up as such, it becomes difficult that the heat transferred to the transparent substrate 1 from the light emitting section 2 is further transferred from the transparent substrate 1 to the periphery of the inlay cavity. This would possibly result in insufficient heat release of the heat generated from the light emitting section 2.

In the state illustrated in (c) or (d) of FIG. 10, the light emitting section 2 is separated off from the side wall of the inlay cavity and from the transparent substrate 1, or the light emitting section 2 is separated off from the side wall of the inlay cavity. This causes loss of thermal connection. This would possibly result in insufficient heat release of the heat generated from the light emitting section 2.

In order to avoid the insulated states as illustrated in (b) to (d) of FIG. 10, it is preferable to configure such that the light emitting section 2 and the inlay cavity is connected via an adhesive layer having an elasticity (as illustrated in (e) of FIG. 10), and the adhesive layer has a sufficient thickness between the inlay cavity and the light emitting section 2 at the bottom and side of the inlay cavity, provided that the thickness of the adhesive layer will not hinder the heat release of the light emitting section 2 via the constituent material of the side wall of the inlay cavity. This alleviates stress caused by the thermal expansion and the thermal shrinkage of the light emitting section 2 and the material in the periphery of the inlay cavity.

[5. Production Method of Light Emitting Elements 10a and 10b)

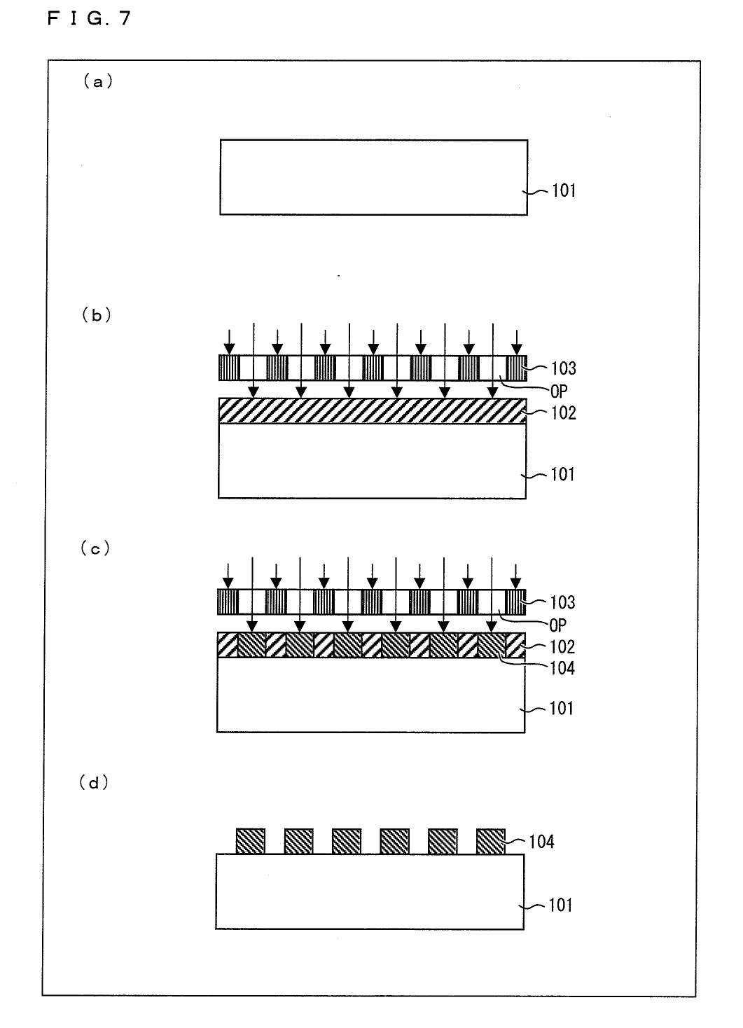

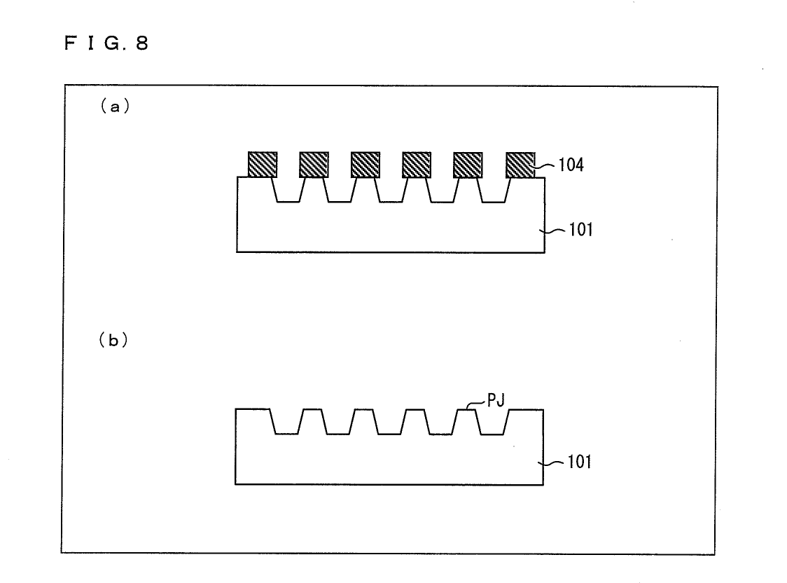

Next, a production method of the light emitting elements 10a and 10b is described, referring to FIGS. 7 and 8. As to a method for forming the microstructure g in the light receiving surface SUF 1 of the transparent substrate 1, a general microfabrication method may be employed.

One examples of forming the microstructure g on glass is to employ embossment for forming the microstructure g. However, embossment may be associated with the following drawbacks.

In case where the microstructure g is formed by embossment to glass in which the fluorescent material is mixed, the glass is heated to its softening point and then a mold having nano meter order-scaled rough structure is pressed against the glass thus heated. When this method is employed for a glass material in which the fluorescent material is dispersed, the fluorescent material is stuck in the roughness of the mold for forming the microstructure g on the glass, thereby making it difficult to form the microstructure g in faithful accordance with the mold. (Here, it is assumed that the roughness of the mold is repeated with several hundred nm intervals, and is several hundred nm in height, while a oxynitride fluorescent material having a particle diameter of 5 to 10 μm at least is used.)

Moreover, hardness of the fluorescent material would possibly give the mold a short life or would possibly require the mold to be harder than the fluorescent material. These would increase a cost of the mold. Further, the need of heating the glass to its softening point after the formation of such a light emitting section would lead to deterioration of the fluorescent material (property deterioration).

One alternative method is to form the microstructure g from a thin organic film formed on a place where anti-reflection is to be provided. This alternative method may be associated with the following drawbacks.

Such a light emitting section 2 have roughness of micro meter order. Thus, it is impossible to form the nano meter-order film thickness uniformly. Thus, it is impossible to form the microstructure g of the nano meter order as desired, thereby failing to obtain a predetermined anti-reflection function.

Moreover, another alternative method is to adhere to the transparent substrate 1a resin film in which the microstructure g is formed in advance. This method is associated with such a drawback that the resin film is highly possibly melted by the heat generation in the light emitting section 2, so that the shape of the microstructure g cannot be maintained for at least a long term.

In view of these, it is preferable that the formation of the microstructure g on the light receiving surface SUF 1 of the transparent substrate 1 is carried out by a combination of (i) lithography using light, x-ray, or electron beam and (ii) etching such as dry etching or wet etching.

In the following, the etching is described, referring to dry etching as one example of the etching. It should be noted that the dry etching is not limited to the one described below, and may be, for example, plasma etching, RIE (Reactive Ion Etching), ECR plasma (Electron Cyclotron Resonance plasma), helicon-wave excited plasma, or the like.

Referring to FIGS. 7 and 8, the following describes how to form the microstructure g on the light receiving surface SUF 1 of the transparent substrate 1 (rough structure forming step) by using dry etching.

The production method of the light emitting element 10a includes the following steps (1) to (6).

(1) A sapphire substrate (transparent substrate) 101 having a 0.5 mm thickness is prepared (see (a) of FIG. 7).

(2) A resist layer 102 is formed on top of the sapphire substrate 101 (see (b) of FIG. 7) by spin coating, wherein the resist layer 102 is made from an organic material.

(3) The resist layer 102 is exposed to ultraviolet light via a mask 103 patterned in a desired pattern, thereby forming the desired pattern (see (b) and (c) of FIG. 7). In the mask 103, openings OP of the mask 103 are portions where transmissivity to the ultraviolet light is higher than the other portions of the mask 103.

(4) The resist layer 102 is developed with a predetermined developing agent, so that unexposed part of the resist layer 102, which part is not exposed to the ultraviolet light, is remained on the sapphire substrate 101 as a remaining portion 104 (see (d) of FIG. 7).

(5) Then, dry etching is carried out with a chlorine-based gas such as SiCl₄ or the like (see (d) of FIG. 7 and (a) of FIG. 8).

(6) Then, the resist layer 102 is removed by using a stripping agent, thereby obtaining an anti-reflection structure having a plurality of projections PJ ((b) of FIG. 8).

In order to form an anti-reflection structure having a complicate shape, the resist layer 102 may be used in combination with a layer made from an inorganic material and a layer made from a metal material. In this case, the cross sectional shape of the sapphire substrate 101 can be controlled.

Next, the production method of the light emitting element 10a further includes a light emitting section providing step for providing the light emitting section 2 in association with the reverse surface SUF 2, which is the reverse side of the light emitting surface SUF 1 (one surface) of the sapphire substrate 101.

For example, in case of the light emitting element 10a, the light emitting section 2 may be bonded to the reverse surface SUF 2 of the sapphire substrate 101 via the adhesive agent as described above, the reverse surface SUF 2 being the reverse side of the light emitting surface SUF 1 (one surface).

On the other hand, in the case of the light emitting element 10b, the light transmissive layer M is vapor-deposited on the reverse surface SUF 2 of the sapphire substrate 101 on one side, and is bonded to the light emitting section 2 on the other side that is reverse to the one side associated with the reverse surface SUF 2.

According to these methods, it is possible to produce a light emitting element 10a or 10b in which the light emitting efficiency of the light emitting section 2 can be increased and the high light emitting efficiency can be maintained for a long time.

The present invention can also be expressed as below.

A light emitting device according to the present invention may be a light emitting device including an excitation light source and a wavelength converting member (light emitting section), wherein excitation light (encompassing laser light) from the excitation light source is used to cause the wavelength converting member to generate light such as fluorescent light. A light emitting device according to the present invention may be a light emitting device including (i) a semiconductor laser as the excitation light source, (ii) a wavelength converting section (light emitting section) for generation illumination light upon receiving the excitation light, (iii) a heat conduction member being coupled with the wavelength converting member and transparent to the excitation light (and the illumination light), and (iv) a microstructure of nano meter order (for example, a moth-eye structure) in one surface of the heat conduction member which surface is a reverse side of another surface of the heat conduction member which another surface is connected with the wavelength converting section.

With this configuration, excitation light used to be reflected from the wavelength converting member and not to reach the fluorescent material can reach the fluorescent material, thereby improving radiation efficiency of the excitation light radiated on the fluorescent material.

Moreover, as a result of this, illumination light used to be reflected by the surface of the wavelength converting member and thereby remained inside the light emitting section can be outputted outside more easily, thereby improving the output efficiency of the illumination light to output the illumination light out of the wavelength converting member. By this, the light emission efficiency of the light emitting section with respect to the power of the excitation light can be improved.

Moreover, the light emitting device according to the present invention may be configured such that a transparent highly-heat conductive member (transparent member, a heat conduction member) having a nano meter-order structure on its surface is provided.

Moreover, the light emitting device according to the present invention may be so configured that the light emitting section includes a sealant, which is inorganic glass whose refractive index is similar to that of the transparent highly-heat conductive member. For example, the transparent highly-heat conductive member may be sapphire substrate (refractive index n=1.785) and the sealant of the light emitting section is a low-melting point glass (refractive index n=1.76).

Moreover, the light emitting device according to the present invention may be configured such that the nano meter-order structure is provided one side of the sapphire substrate, which side is reverse to the side thereof to which the light emitting section is connected.

By this, the light emitting section from which heat is generated due to the radiation of the laser light of high power and high power density can be cooled more quickly by the transparent highly-heat conductive material. Moreover, the refractive index difference between the light emitting section and the transparent highly heat conductive material is very small, thereby causing almost no reflection at a boundary between them. Thus, the anti-reflection structure formed on the surface of the transparent highly-heat conductive material can be effective.

For example, at the boundary between the sapphire substrate (refractive index n=1.785) and the air (refractive index n=1), a 7.9% surface reflection occurs. This surface reflection can be reduced to substantially 0% by forming the nano meter-order structure on the sapphire surface. On the other hand, at the boundary between the sapphire substrate and inorganic glass (refractive index n=1.76), the degree of reflection is 0.005%, which is substantially 0%. Because of this, the excitation light can reach with almost no degree of reflection from the air to the inorganic glass constituting the light emitting section (via the sapphire substrate).

Most of (transparent) highly heat conductive materials have high melting points and can sustain their initial shapes even if the light emitting section is heated to a high temperature by the radiation of the laser light.

### Another Expressions of Present Invention

The present invention can be also expressed as follows.

The light emitting element according to the present invention may be arranged such (i) that the protruded parts have a portion whose cross section in parallel with the light receiving surface is constant in diameter, the portion being located between a bottom and a top of the protruded parts, (ii) that the protruded parts have a portion whose cross section in parallel with the light receiving surface becomes greater in diameter in a direction directed from a bottom of the protruded parts toward a top of the protruded parts, or (iii) that the protruded parts have a portion whose cross section in parallel with the light receiving surface becomes smaller in diameter in a direction directed from a bottom of the protruded parts toward a top of the protruded parts.

The light emitting element according to the present invention may be configured such that the recessed parts are not uniform in terms of their recessed part depths along a direction perpendicular to the light receiving surface and in terms of their recessed part widths along a direction parallel with the light receiving surface.

The light emitting element according to the present invention may be configured such that a refractive index difference between the transparent substrate and the light emitting section is 0.35 or less.

Assuming the refractive indexes of the light emitting section and the transparent substrate are in a range of 1.5 to 2.0 approximately, the degree of reflection at the boundary between the light emitting section and the transparent substrate would be 1% if the refractive index difference between the light emitting section and the transparent substrate was 0.35 while the refractive index of one of the light emitting section and the transparent substrate was 1.5 (that is, the refractive index of the other one of the light emitting section and the transparent substrate was 1.85).

Moreover, in case the refractive index of one of the light emitting section and the transparent substrate is 2.0, the degree of reflection at the boundary between the light emitting section and the transparent substrate would be 0.92% if the refractive index difference between the light emitting section and the transparent substrate was 0.35 (that is, the refractive index of the other one of the light emitting section and the transparent substrate was 1.65).

Therefore, if the refractive index difference between the light emitting section and the transparent substrate is 0.35 or less, the degree of reflection at the boundary between the light emitting section and the transparent substrate can be 1% or less.

Moreover, the light emitting element according to the present invention may be configured such that the transparent substrate has a refractive index of 1.65 or greater.

As described above, when the upper limit of the refractive index is 2.0, it is possible to satisfy the refractive index difference of 0.35 or less for the light emitting section of refractive index of 1.5 to 2.0 if the refractive index of the transparent substrate is 1.65 or more.

Moreover, the light emitting section according to the present invention may be configured such that the transparent substrate is greater than the light emitting section in terms of heat conductivity.

With this configuration, the heat release from the light emitting section to the transparent substrate can be easier, thereby improving the cooling efficiency of the light emitting section.

Moreover, the light emitting section according to the present invention may be configured such that at least the transparent substrate is surrounded by dry air.

For example, if the material of the transparent substrate has a deliquescent property, the rough structure of the transparent substrate would be damaged due to the deliquescent property. However, even in such a case, this configuration in which the transparent substrate is surrounded with dry air can prevent the rough structure from being damaged due to the deliquescent property.

Moreover, the light emitting section according to the present invention may be configured such that a distance between the light receiving surface and the reverse surface is 30 μm or more.

If the distance between the light receiving surface and the reverse surface (i.e., the thickness of the transparent substrate) is less than 30 μm, the heat release of the light emitting section cannot be sufficient, thereby deteriorating the light emitting section. Moreover, the rough structure would be damaged due to the heat generated from the light emitting section.

Moreover, the light emitting section according to the present invention may be configured such that the transparent substrate has a heat conductivity of 20 W/mK or greater.

This makes it possible to achieve efficient heat release of the heat generated from the light emitting section.

Moreover, the light emitting section according to the present invention may be configured such that the protruded parts are arranged without regular intervals at least in one direction along the light receiving surface.

By this, diffraction of the excitation light is prevented in the direction in which the protruded parts are arranged without regular intervals. This further decreases the degree of reflection of the excitation light radiated on the transparent substrate.

Moreover, the light emitting section according to the present invention may be configured such that the predetermined wavelength of the excitation light is 1000 nm or less.

Excitation light having a wavelength exceeding 1000 nm overexcites the fluorescent material, thereby making it impossible to obtain fluorescent light in a visible light region.

Moreover, the light emitting section according to the present invention may be configured such that the protruded parts are not higher than 3000 nm in terms of protruded part height that is a length from a bottom of the protruded parts to a top of the protruded parts.

Protruded parts higher than 3000 nm in terms of protruded part height are not so effective in anti-reflection and reflection reduction.

Moreover, the light emitting section according to the present invention may be configured such that the intervals are not less than 5 nm but not more than 3000 nm.

If the intervals capable of reducing the reflection are less than 5 nm, it becomes difficult to form the rough structure. Here, the width of the protruded parts along the light receiving surface is referred to as protruded part width. In this case, the intervals capable of reducing the reflection are substantially equal to the protruded part width.

As described above, the preferable upper limit of the protruded part width is 3000 nm. If the intervals capable of reducing the reflection exceeds 3000 nm, the aspect ratio of the protruded ratio (protruded part height/protruded part width) becomes smaller than 1, thereby making it difficult to attain sufficient reduction in degree of reflection.

Moreover, a light emitting device according to the present invention is a light emitting device, comprising: any of these light emitting elements; and an excitation light source for radiating the excitation light to the light receiving surface of the transparent substrate.

With this, it becomes possible to provide a light emitting device in which the light emission efficiency of the light emitting section is increased, and the high light emission efficiency can be maintained for a long time.

The light emitting device according to the present invention may be configured such that the excitation light source is a light emitting diode.

This configuration brings about the following advantages. The light emitting diode is small in size. Therefore, the use of the light emitting diode to constitute the excitation light source makes it possible to further miniaturize the light emitting device including the excitation light source and the light emitting section, and further to give a greater degree of freedom as to varieties and designing of products to which the light emitting device is applied. In addition, the refractive index boundary to which the excitation light is incident and on which the rough structure is formed is distanced from the thermal boundary to which the heat from the light emitting section which is the greatest heat source among constituent elements of the light emitting element is conducted to the transparent substrate 1. Thereby, the heat generated by the excited fluorescent material is released to the transparent substrate, thereby lowering an environmental temperature of the fluorescent material. This prevents reduction in efficiency of the light emitting section, which reduction is caused by the increase in environmental temperature of the fluorescent material. This contributes further miniaturization and lower power consumption of the light emitting device.

The light emitting device according to the present invention may be configured such that the excitation light source is a laser light source.

With this configuration, the use of the laser light source makes it possible to obtain excitation light of very high power and very high power density, thereby making it possible for the light emitting section to output illumination light having high brightness and high flux of light. Moreover, the refractive index boundary on which the excitation light is incident and on which the rough structure is formed is distanced from the thermal boundary from which the heat generated from the light emitting section, which is the greatest heat source among the constituent elements of the light emitting element, is conducted. As a result, the rough structure is not damaged by the heat from the light emitting section.

The light emitting device according to the present invention may be configured such that the laser light source is a semiconductor laser.

With this configuration, the semiconductor laser is small in size. Therefore, the use of the semiconductor laser to constitute the excitation light source makes it possible to further miniaturize the light emitting device including the excitation source and the light emitting section, and further to give a greater degree of freedom as to varieties and designing of products to which the light emitting device is applied.

The light emitting device according to the present invention may be configured to further comprises a reflective mirror having a light reflective concave surface for reflecting the fluorescent light generated from the light emitting section, the light emitting section being provided in an inlay cavity formed in the reflective mirror, and being configured to allow part of the excitation light to pass through inside of the light emitting section.

With this configuration, the excitation light passing inside the light emitting section is scattered by the fluorescent material particles included in the light emitting section. Thus, the light thus scattered is diffused inside the reflective mirror.

Moreover, the light emitting device according to the present invention may be configured to further comprise a heat conduction member having (i) an inlay cavity in which the light emitting section is provided, and (ii) a heat conductivity for diffusing heat generated from the light emitting section, the light emitting section is provided in the inlay cavity in such a way that one side of the light emitting section is inlayed in the inlay cavity, the one side being reverse to another side of the light emitting section, on which another side the light emitting section receives the excitation light having passed through the transparent substrate.

In this configuration, the light emitting section is inlayed inside the inlay cavity and surrounded with the transparent substrate and the heat conduction member. This improves cooling effect for cooling the light emitting section.

Moreover, the light emitting device according to the present invention may be configured such that the inlay cavity has a light reflective bottom surface that reflects that part of the excitation light which has passed through inside the light emitting section.

With this configuration, the excitation light passing through inside the light emitting section is reflected from a bottom surface of the inlay cavity in the heat conduction member. Thus, the excitation light has a double light path length inside the light emitting section. By this, it is possible to obtain sufficient light emitting efficiency even when the light emitting section with a certain concentration of the fluorescent material is halved in thickness in the radiation direction of the excitation light.

Moreover, the light emitting device according to the present invention may be configured such that the heat conduction member is made from a metal.

The metal has a high heat conductivity and thus the use of metal is expected to contribute to the heat release effect of the heat conduction member.

Moreover, the light emitting device according to the present invention may be configured such that the heat conduction member is made from ceramics.

Moreover, for example, in case where the transparent substrate is made from glass or sapphire, the use of ceramics as the constituent material of the heat conduction member can prevent the transparent substrate from being separated from the inlay cavity (i.e., from being thermally insulated by being thermally separated off) as a result of repeated expansion and shrinkage of the light emitting section repeatedly heated by repeated radiation to the light emitting section. The use of ceramics as the constituent material of the heat conduction member can do so because the ceramics, glass, and sapphire have similar coefficients of thermal expansion.

[Additional Statement]

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

The present invention is applicable to light emitting elements, light emitting devices and illuminating devices provided with the light emitting element. For example, the present invention is applicable to automobile head lamps, head lamps for vehicles or moving objects (for example, human, vessels, air planes, submarines, rockets, etc.) other than automobiles. Moreover, the present invention is also applicable to other illuminating devices such as search lights, projectors, indoor or outdoor illumination devices, etc.

### REFERENCE SIGNS LIST

1: Transparent Substrate
2: Light Emitting Section
3: Laser Light Source
   (Excitation Light Source, Semiconductor Laser)
4: Parabola Reflective Mirror (Reflective Mirror)
4h: Half Parabola Reflective Mirror (Reflective Mirror)
4p: Heat Conduction Member
10a, 10b: Light Emitting Elements
20: Transmissive Type Light emitting device
   (Light emitting device)
30: Reflective Type Light emitting device
   (Light Emitting Device)
101: Sapphire Substrate (Transparent Substrate)
d: Interval (Interval capable of reducing reflection)
dep1 to dep4: Recessed Part Depth
w1 to w4: Recessed Part Width
g: Microstructure (Rough Structure)
h, h1 to h4: Height (Protruded Part Height)
H: Thickness (distance between light receiving surface and its reverse surface)
L: Laser Light (Excitation Light)
PJ: Projection (Protruded Part)
PH: Fine Pores (Recessed Part)
SUF 1: Light Receiving Surface (One Surface)
SUF 2: Reverse surface (Reverse Surface)
SUF 3: Light Reflective Concave Surface

1. A light emitting element, comprising:
a transparent substrate (i) having a light receiving surface to which excitation light having a predetermined wavelength is to be radiated, and a reverse surface being opposite to the light receiving surface and (ii) being transparent to the excitation light; and
a light emitting section being positioned to face of the reverse surface of the transparent substrate, and being configured to generate fluorescent light upon receiving the excitation light having passed through the transparent substrate,
the transparent substrate being heat conductive so as to receive heat generated from the light emitting section and allow diffusion of the heat, and
the light receiving surface of the transparent substrate having or provided with a rough structure having either or both of a plurality of protruded parts or a plurality of recessed parts with intervals capable of reducing reflection of the excitation light from the light receiving surface.

2. The light emitting element as set forth in claim 1, wherein the protruded parts have a portion whose cross section in parallel with the light receiving surface is constant in diameter, the portion being located between a bottom and a top of the protruded parts.

3. The light emitting element as set forth in claim 1, wherein the protruded parts have a portion whose cross section in parallel with the light receiving surface becomes greater in diameter in a direction directed from a bottom of the protruded parts toward a top of the protruded parts.

4. The light emitting element as set forth in claim 1, wherein the recessed parts are not uniform in terms of their recessed part depths along a direction perpendicular to the light receiving surface and in terms of their recessed part widths along a direction parallel with the light receiving surface.

5. The light emitting element as set forth in claim 1, wherein the protruded parts have a portion whose cross section in parallel with the light receiving surface becomes smaller in diameter in a direction directed from a bottom of the protruded parts toward a top of the protruded parts.

6. The light emitting element as set forth in claim 1, wherein a refractive index difference between the transparent substrate and the light emitting section is 0.35 or less.

7. The light emitting element as set forth in claim 1, wherein the transparent substrate has a refractive index of 1.65 or greater.

8. The light emitting element as set forth in claim 1, wherein the transparent substrate is greater than the light emitting section in terms of heat conductivity.

9. The light emitting element as set forth in claim 1, wherein at least the transparent substrate is surrounded by dry air.

10. The light emitting element as set forth in claim 1, wherein a distance between the light receiving surface and the reverse surface is 30 μm or more.

11. The light emitting element as set forth in claim 1, wherein the transparent substrate has a heat conductivity of 20 W/mK or greater.

12. The light emitting element as set forth in claim 1, wherein the protruded parts are arranged without regular intervals at least in one direction along the light receiving surface.

13. The light emitting element as set forth in claim 1, wherein the predetermined wavelength of the excitation light is 1000 nm or less.

14. The light emitting element as set forth in claim 1, wherein the protruded parts are not higher than 3000 nm in terms of protruded part height that is a length from a bottom of the protruded parts to a top of the protruded parts.

15. The light emitting element as set forth in claim 1, wherein the intervals are not less than 5 nm but not more than 3000 nm.

16. A light emitting device, comprising:
a light emitting element as set forth in claim 1; and
an excitation light source for radiating the excitation light to the light receiving surface of the transparent substrate.

17. The light emitting device as set forth in claim 16, wherein the excitation light source is a light emitting diode.

18. The light emitting device as set forth in claim 16, wherein the excitation light source is a laser light source.

19. The light emitting device as set forth in claim 18, wherein the laser light source is a semiconductor laser.

20. The light emitting device as set forth in claim 16, further comprising:
a reflective mirror having a light reflective concave surface for reflecting the fluorescent light generated from the light emitting section,
the light emitting section being provided in an inlay cavity formed in the reflective mirror, and being configured to allow part of the excitation light to pass through inside of the light emitting section.

21. The light emitting device as set forth in claim 16, further comprising:
a heat conduction member having (i) an inlay cavity in which the light emitting section is provided, and (ii) a heat conductivity for diffusing heat generated from the light emitting section,
the light emitting section is provided in the inlay cavity in such a way that one side of the light emitting section is inlayed in the inlay cavity, the one side being reverse to another side of the light emitting section, on which another side the light emitting section receives the excitation light having passed through the transparent substrate.

22. The light emitting device as set forth in claim 21, wherein the inlay cavity has a light reflective bottom surface that reflects that part of the excitation light which has passed through inside the light emitting section.

23. The light emitting device as set forth in claim 21, wherein the heat conduction member is made from a metal.

24. The light emitting device as set forth in claim 21, wherein the heat conduction member is made from ceramics.

25. A method for producing a light emitting element being transparent to light emitting light having a predetermined wavelength, and a light emitting section for generating fluorescent light upon receiving the excitation light, the method comprising:
a rough structure forming step for forming a rough structure so that one surface of the transparent has the rough structure, the rough structure having either or both of a plurality of protruded parts or a plurality of recessed parts with intervals capable of reducing reflection of the excitation light from the light receiving surface; and
a light emitting section providing step for providing the light emitting section at a position to face of a reverse surface of the transparent substrate, which reverse surface is reverse to the one surface of the transparent substrate,
the transparent substrate being made from a material having a heat conductivity to receive heat generated from the light emitting section and allow diffusion of the heat.
